(19) United States
(12) Patent Application Publication
(10) Pub. No.: US 2016/0011560 A1
(43) Pub. Date: Jan. 14, 2016

(54) SHAFT-MEMBER DETACHMENT METHOD AND SHAFT-MEMBER DETACHING TOOL

(71) Applicant: MITSUBISHI CHEMICAL CORPORATION, Chiyoda-ku (JP)

(72) Inventors: Shinichi IIJIMA, Singapore (SG); Shuichi Ikeda, Odawara-shi (JP); Wataru Miyashita, Odawara-shi (JP); Susumu Taguchi, Odawara-shi (JP); Takeshi Hiramatsu, Odawara-shi (JP)

(73) Assignee: MITSUBISHI CHEMICAL CORPORATION, Chiyoda-ku (JP)

(21) Appl. No.: 14/862,460

(22) Filed: Sep. 23, 2015

Related U.S. Application Data
(63) Continuation of application No. PCT/JP2014/058135, filed on Mar. 24, 2014.
(60) Provisional application No. 61/805,039, filed on Mar. 25, 2013.

(30) Foreign Application Priority Data
Nov. 6, 2013 (JP) 2013-230374
Nov. 6, 2013 (JP) 2013-230395
Nov. 6, 2013 (JP) 2013-230405

(51) Int. Cl. G03G 21/16

(52) U.S. Cl. CPC G03G 21/1647; G03G 21/1671

(57) ABSTRACT

There is provided a method for detaching a shaft member swingably held by a bearing member from the bearing member which transmits a rotating force to a photoreceptor drum, wherein the shaft member includes a base end section received inside the bearing member, a rotating force transmission pin which protrudes from the base end section, and a rotating force receiving section which is disposed to protrude from the bearing member, and the method includes a process of detaching the shaft member from the bearing member by a force acting on the base end section.

### CROSS REFERENCE TO RELATED APPLICATION(S)

This application is a continuation of International Patent Application No. PCT/JP2014/058135 filed on Mar. 24, 2014, claiming the benefit of priorities of U.S. Provisional Patent Application No. 61/805,039 filed on Mar. 25, 2013, and Japanese Patent Application No. 2013-230374, Japanese Patent Application No. 2013-230395, and Japanese Patent Application No. 2013-230405 all filed on Nov. 6, 2013, the contents of which are incorporated herein by reference in its entirety.

### BACKGROUND OF THE INVENTION

1. Field of the Invention

The present invention relates to a method for detaching a shaft member which configures an end member provided in an image forming apparatus, such as a laser printer or a copying machine, from a bearing member of the end member, and a tool for the method.

2. Description of the Related Art

In an image forming apparatus, such as a laser printer or a copying machine, a process cartridge which is attachable to and detachable from an image forming apparatus body (hereinafter, referred to as an “apparatus body”) is provided.

The process cartridge is a member which forms contents to be expressed by letters or figures and transfers the contents to a recording medium, such as a paper sheet. More specifically, the process cartridge includes a photoreceptor drum, and here, the contents to be transferred is formed. In addition, in the process cartridge, various means for forming the contents to be transferred to the photoreceptor drum are disposed together. Examples of these means include means for developing, means for charging the photoreceptor drum, and means for cleaning the photoreceptor drum.

In case of the process cartridge, the same process cartridge is attached to and detached from the apparatus body for maintenance, or a new process cartridge is mounted on the apparatus body by detaching an old process cartridge from the apparatus body in order to replace the process cartridge with a new process cartridge. Attaching and detaching the process cartridge in this manner is performed by users of the image forming apparatus manually, and it is desirable to easily perform attaching and detaching as much as possible from such a point of view.

However, a drive shaft of the apparatus body is engaged with the photoreceptor drum which is included in the process cartridge directly or via another member, and according to this, the photoreceptor drum receives a rotating force from the drive shaft and rotates. Therefore, in order to attach and detach the process cartridge to and from the apparatus body, it is necessary to release (detach) the engagement between the drive shaft of the apparatus body and the photoreceptor drum, and to reengage (mount) the process cartridge again.

Here, if it is possible to move the photoreceptor drum (process cartridge) in an axial line direction of the drive shaft of the apparatus body, and to attach and detach the photoreceptor drum, configuring an apparatus for this can be relatively easy. However, from the viewpoint of reducing the size of the image forming apparatus or ensuring space for the attachment and detachment of the process cartridge, it is preferable that the process cartridge is detached from the apparatus body and falls out in a direction which is different from the axial line direction of the drive shaft, and that mounting the process cartridge to the apparatus body is done by pushing in this direction.

In JP-A-2010-26473 as Patent Literature 1, a configuration for attaching and detaching a process cartridge in a direction which is different from an axial line direction of a drive shaft of an apparatus body is disclosed. Specifically, a coupling member (shaft member) which is disclosed in JP-A-2010-26473 is swingably attached to a chum flange (bearing member) by providing a spherical section. Therefore, a part (rotating force receiving member) which is provided in the coupling member and engages with the drive shaft of the apparatus body can swing around the spherical section, an angle with respect to the shaft line of the photoreceptor drum can be changed, and mounting and disengagement between the drive shaft of the apparatus body and the photoreceptor drum become easier.

Meanwhile, even after using the process cartridge, the number of components which can be reused is large, and the shaft member is also one of these components. In contrast to this, a method for detaching the shaft member from the bearing member is disclosed in U.S. Pat. No. 7,885,575 as Patent Literature 2. Specifically, among the shaft members, a shaft member is removed by grabbing and pulling a rotating force receiving section which has an increased diameter.

Patent Literature 1: JP-A-2010-26473

Patent Literature 2: U.S. Pat. No. 7,885,575

### SUMMARY OF THE INVENTION

However, when forcibly detaching the shaft member from the bearing member by grabbing the rotating force receiving section as described in U.S. Pat. No. 7,885,575, there is a concern that the rotating force receiving section is damaged. In addition, it is not possible to say that the efficiency is excellent from the viewpoint of production, and there is room for improvement.

Here, in consideration of the above-described problems, a non-limited object of the present invention is to provide a method for detaching the shaft member from the bearing member without damaging the rotating force receiving section. In addition, a tool for the method is provided.

Hereinafter, some non-limited aspects of the present invention will be described.

According to the present invention, there is provided a shaft-member detachment method for detaching a shaft member swingably held by a bearing member from the bearing member which transmits a rotating force to a photoreceptor drum, wherein the shaft member includes a base end section received inside the bearing member, a rotating force transmission pin which protrudes from the base end section, and a rotating force receiving section which is disposed to protrude from the bearing member, and the method includes a process of detaching the shaft member from the bearing member by a force acting on the base end section.

According to an aspect of the shaft-member detachment method of the present invention, the detaching process includes a procedure of holding and pulling out the shaft member by nipping the base end section.

According to an aspect of the shaft-member detachment method of the present invention, the detaching process includes a procedure of pulling out the shaft member while supporting at least one point on a side opposite to the rotating force receiving section in the base end section.

According to an aspect of the shaft-member detachment method of the present invention, the detaching process includes a procedure in which one end of a bar-like member is brought into contact with the base end section and serves as a point of application, in which a part of the bar-like member is brought into contact with the bearing member and serves as a fulcrum, and a force is applied to the other end of the bar-like member and the other end serves as leverage.

According to an aspect of the shaft-member detachment method of the present invention, the detaching process includes a procedure of pressing the base end section from a side opposite to the rotating force receiving section in the base end section.

In addition, according to the present invention, there is provided a shaft-member detaching tool which is used in the shaft-member detachment method, and includes at least two parts which sandwich the base end section.

In addition, according to the present invention, there is provided a shaft-member detaching tool which is used in the shaft-member detachment method, includes a part which has a shape of a bar and makes the base end section hooked to a tip end of the bar-shaped part.

In addition, according to the present invention, there is provided a shaft-member detaching tool which is used in the shaft-member detachment method, has a shape of a bar to be inserted into the bearing member.

In addition, according to the present invention, there is provided a shaft-member detachment method for detaching a shaft member swingably held by a bearing member from the bearing member which transmits a rotating force to a photoreceptor drum, wherein the shaft member includes a base end section received inside the bearing member, a rotating force transmission pin which protrudes from two locations of the base end section, and a rotating force receiving section which is disposed to protrude from the bearing member, and the method includes a process of detaching the shaft member from the bearing member by a force acting on the rotating force transmission pin.

According to an aspect of the shaft-member detachment method of the present invention, the detaching process includes a procedure of pulling out the shaft member while supporting at least two locations of the rotating force transmission pin.

According to an aspect of the shaft-member detachment method of the present invention, the detaching process includes a procedure of pulling out the shaft member by catching the rotating force transmission pin with a wire and pulling the wire.

According to an aspect of the shaft-member detachment method of the present invention, the detaching process includes a procedure of catching one rotating force transmission pin with the wire, pulling the wire, making the shaft member inclined, and applying a force in the direction in which the shaft member stands.

According to an aspect of the shaft-member detachment method of the present invention, the detaching process includes a procedure in which one end of a bar-like member is brought into contact with the rotating force transmission pin and serves as a point of application, in which a part of the bar-like member is brought into contact with the bearing member and serves as a fulcrum, and a force is applied to the other end of the bar-like member and the other end serves as leverage.

In addition, according to the present invention, there is provided a shaft-member detaching tool which is used in the shaft-member detachment method, and includes at least two engagement sections which make each of one side end section and the other side end section of the rotating force transmission pin caught.

In addition, according to the present invention, there is provided a shaft-member detachment method for detaching a shaft member swingably held by a bearing member from the bearing member which transmits a rotating force to a photoreceptor drum, wherein the shaft member includes a base end section received inside the bearing member, a rotating force transmission pin which protrudes from two locations of the base end section, and a rotating force receiving section which is disposed to protrude from the bearing member, and the method includes a process of detaching the shaft member from the bearing member by directly deforming at least a part of the bearing member.

Here, “deformation” is a concept which includes both “deformation accompanied by damage” and “deformation which is not accompanied by damage”.

According to an aspect of the shaft-member detachment method of the present invention, the detaching process includes a procedure of at least partly damaging an outer circumferential section of the bearing member.

According to an aspect of the shaft-member detachment method of the present invention, the detaching process includes a procedure of at least partly damaging a part which comes into contact with the base end section of the shaft member among parts received inside the bearing member.

According to an aspect of the shaft-member detachment method of the present invention, the detaching process includes a procedure of pressing the shaft member toward an outside from an inside of the bearing member, and damaging an outer wall of the bearing member by pushing down the outer wall.

According to an aspect of the shaft-member detachment method of the present invention, the method includes a process of cooling the bearing member performed before the detaching process.

According to an aspect of the shaft-member detachment method of the present invention, the detaching process includes a procedure of cooling the shaft member and the bearing member, and a procedure of imparting an impact to the bearing member after the cooling.

According to an aspect of the shaft-member detachment method of the present invention, the detaching process includes a procedure of deforming which is not accompanied by damage after heating the bearing member.

According to the present invention, since it is not necessary to impart a force to the rotating force receiving section when detaching the shaft member held by the bearing member in the end member, it is possible to prevent scratches or damage to the rotating force receiving section. Therefore, it is possible to enhance the quality of the reused shaft member.

### BRIEF DESCRIPTION OF THE DRAWINGS

FIG. 1 is a schematic view of an image forming apparatus body and a process cartridge.

FIG. 2A is a perspective view of an external appearance of a photoreceptor-drum unit according to one example.

FIG. 2B is a perspective view of an external appearance of an end member.

FIG. 3A is a perspective view of an external appearance of a bearing member.

FIG. 3B is a plan view of the bearing member.

FIG. 4A is a sectional view along line IVa-IVa of FIG. 3B.

FIG. 4B is a sectional view along line IVb-IVb of FIG. 3B.

FIG. 5 is an enlarged view of a part of FIG. 4B.

FIG. 6A is a sectional view along line VIa-VIa of a shaft member illustrated in FIG. 2B.

FIG. 6B is a sectional view along line VIb-VIb of the shaft member illustrated in FIG. 2B.

FIG. 7A is a sectional view along line IVa-IVa of FIG. 3B in the end member.

FIG. 7B is a sectional view along line IVb-IVb of FIG. 3B in the end member.

FIG. 8 is an enlarged view of a part of FIG. 7B.

FIG. 9A is a perspective view of an external appearance in one posture of a tool used in a first embodiment.

FIG. 9B is a perspective view of an external appearance in another posture of the tool used in the first embodiment.

FIG. 10A is a sectional view illustrating a situation in which a spherical body is grabbed by the tool.

FIG. 10B is a sectional view illustrating a situation in which the shaft member is detached from the bearing member.

FIG. 11 is a perspective view of an external appearance of a tool used in a second embodiment.

FIG. 12A is a sectional view illustrating a situation in which the tool is put into the bearing member.

FIG. 12B is a sectional view illustrating a situation in which the tool is put into a bottom section of the spherical body of the shaft member.

FIG. 12C is a sectional view illustrating a situation in which the shaft member is detached and lifted up from the bearing member by the tool.

FIG. 13 is a perspective view of an external appearance of a tool which is used in a third embodiment.

FIG. 14A is a sectional view illustrating a situation of a procedure of detaching the shaft member from the bearing member according to the embodiment.

FIG. 14B is a sectional view illustrating another situation of a procedure of detaching the shaft member from the bearing member according to the embodiment.

FIG. 15A is a sectional view illustrating a situation in which a tool is put into the bearing member according to a fourth embodiment.

FIG. 15B is a sectional view illustrating a situation in which the tool according to the fourth embodiment is inclined.

FIG. 15C is a sectional view illustrating a situation in which the shaft member is detached from the bearing member by the tool.

FIG. 16A is a sectional view illustrating a situation in which an expansion section is grabbed by the tool.

FIG. 16B is a sectional view illustrating a situation in which the shaft member is detached from the bearing member.

FIG. 17A is a sectional view illustrating a situation in which one end section of the tool is hooked to the expansion section.

FIG. 17B is a sectional view illustrating a situation in which the shaft member is detached from the bearing member.

FIG. 18A is a perspective view of an external appearance illustrating one situation of a procedure in which the shaft member is detached from the bearing member by using wire.

FIG. 18B is a perspective view of an external appearance illustrating another situation.

FIG. 19 is a perspective view of an external appearance of a tool which is used in a fifth embodiment.

FIG. 20A is a perspective view illustrating that a rotating force transmission pin is held by the tool.

FIG. 20B is a perspective view illustrating a situation in which the shaft member is detached from the bearing member.

FIG. 21A is a perspective view of an external appearance illustrating one situation of a procedure of detaching the shaft member from a bearing member 45.

FIG. 21B is a perspective view of an external appearance illustrating another situation.

FIG. 22A is a perspective view of an external appearance illustrating one situation of a procedure of detaching the shaft member from the bearing member in the embodiment.

FIG. 22B is a perspective view of an external appearance illustrating another situation.

FIG. 22C is a perspective view of an external appearance illustrating still another situation.

FIG. 23A is a perspective view of an external appearance illustrating one situation of a procedure of detaching the shaft member from the bearing member.

FIG. 23B is a perspective view of an external appearance illustrating another situation.

FIG. 24A is a sectional view illustrating a situation in which the tool is hooked to the rotating force transmission pin.

FIG. 24B is a sectional view illustrating a situation in which the shaft member is detached from the bearing member by the tool.

FIG. 25A is a perspective view of an external appearance of a tool which is used in a tenth embodiment.

FIG. 25B is an enlarged perspective view of a tip end section of the tool.

FIG. 26A is a diagram illustrating that the rotating force transmission pin is held by the tool.

FIG. 26B is a diagram illustrating a situation in which the shaft member is detached from the bearing member.

FIG. 27A is a perspective view of an external appearance of a tool used in the eleventh embodiment.

FIG. 27B is an enlarged perspective view of a part of the tool.

FIG. 28A is a perspective view of an external appearance illustrating one situation of a procedure of detaching the shaft member from the bearing member.

FIG. 28B is a perspective view of an external appearance illustrating another situation.

FIG. 28C is a perspective view of an external appearance illustrating still another situation.

FIG. 29 is an enlarged view illustrating a procedure of detaching the shaft member from the bearing member.

FIG. 30 is a perspective view of an external appearance of a tool which is used in a twelfth embodiment.

FIG. 31A is a perspective view of an external appearance illustrating one situation of a procedure of detaching the shaft member from the bearing member.

FIG. 31B is a sectional view thereof.

FIG. 32 is a sectional view illustrating another situation of a procedure of detaching the shaft member from the bearing member.

FIG. 33A is a perspective view of an external appearance in one posture of a tool which is used in a thirteenth embodiment.

FIG. 33B is a perspective view of an external appearance in another posture of the tool which is used in the thirteenth embodiment.

FIG. 34A is sectional view in one posture of the tool which is used in the thirteenth embodiment.

FIG. 34B is a sectional view in another posture of the tool which is used in the thirteenth embodiment.

FIG. 35A is a sectional view illustrating one situation of a procedure of detaching the shaft member from the bearing member.

FIG. 35B is a sectional view illustrating another embodiment.

FIG. 36A is a sectional view illustrating one situation of a procedure of detaching the shaft member from the bearing member.

FIG. 36B is a sectional view illustrating another situation.

FIG. 37 is a diagram illustrating an example of taking out the shaft member by deformation which is not accompanied by damage of the bearing member.

### DETAILED DESCRIPTION OF THE EXEMPLARY EMBODIMENTS

The above-described effects and advantages of the present invention are apparent from the embodiments for implementing the invention which will be described in the following. Hereinafter, the present invention will be described based on the embodiments illustrated in the drawings. However, the present invention is not limited to the embodiments.

First, a structure of an end member 40 will be described by referring to an embodiment. In addition, after this, a method for detaching a shaft member 70 and a tool for the method will be described by using the example of the end member 40.

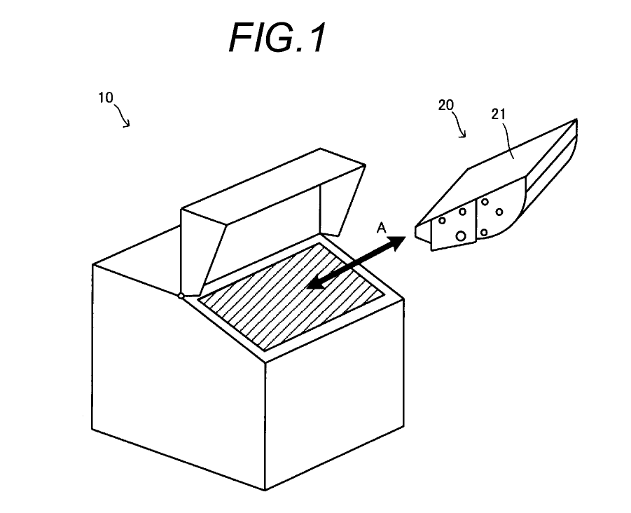

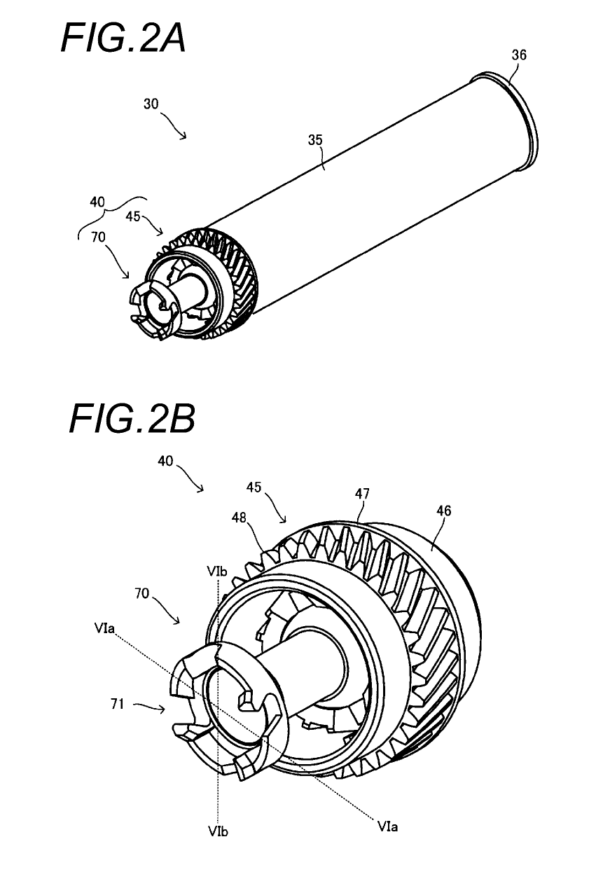

FIG. 1 is a diagram illustrating one embodiment, and is a perspective view schematically illustrating a process cartridge 20 which is provided with the end member 40 (refer to FIG. 2B), and an image forming apparatus body 10 (hereinafter, there is a case where the image forming apparatus body 10 is described as an “apparatus body 10”) which has the process cartridge 20 mounted thereon and uses the process cartridge 20. The process cartridge 20 illustrated in FIG. 1 can be mounted onto and disengaged from the apparatus body 10 by being moved in a direction illustrated with A in FIG. 1. The direction is a direction which is different from an axial line direction of a drive shaft of the apparatus body 10. In addition, the apparatus body 10 and the process cartridge 20 configure the image forming apparatus, and hereinafter, will be described in detail.

The process cartridge 20 includes a housing 21 which forms an outline of the process cartridge 20, and various components inside thereof. Specifically, in the embodiment, in addition to a photoreceptor-drum unit 30 (refer to FIG. 2A), a charging roller, a developing roller, a developing blade, a transfer roller, and a cleaning blade are provided.

In the photoreceptor-drum unit 30, letters or figures to be transferred to a recording medium, such as a paper sheet, are formed. FIG. 2A illustrates a perspective view of an external appearance of the photoreceptor-drum unit 30. As can be ascertained from FIG. 2A, the photoreceptor-drum unit 30 is provided with a photoreceptor drum 35, a lid member 36, and an end member 40. FIG. 2B is a perspective view focusing on the end member 40. Hereinafter, with reference to FIGS. 2A and 2B and appropriate drawings, the photoreceptor-drum unit 30 will be described.

The photoreceptor drum 35 is a member which is covered with a photoreceptor layer on an outer circumferential surface of a drum cylinder which has a cylindrical shape. In other words, the drum cylinder is covered with the photoreceptor layer on a conductive cylinder, such as aluminum. The end member 40 is attached to one end of the photoreceptor drum 35 as will be described later, and the lid member 36 is disposed at the other end. Here, the drum cylinder has a cylindrical shape, but may have a solidly columnar shape. However, at least the lid member 36 and the end member 40 are formed to be appropriately attached to the end sections of the drum cylinder.

The lid member 36 is a member which is formed of a resin, and a fitting section which is fitted to the inside of the cylinder of the photoreceptor drum 35, and a bearing section which is disposed to cover one end surface of the photoreceptor drum 35 are formed coaxially. The bearing section has a shape of a disk which covers the end surface of the photoreceptor drum 35, and is provided with a part that receives a shaft. In addition, an earth plate which is made of a conductive material is disposed in the lid member 36, and according to this, the photoreceptor drum 35 and the apparatus body 10 are electrically connected to each other.

In addition, here, an example of the lid member is described, but the lid member is not limited thereto, and it is possible to employ a lid member which can be generally obtained according to another embodiment. For example, a gear for transmitting a rotating force to the lid member may be disposed.

In addition, the above-described conductive material may be provided on the end member 40 side which will be described later.

The end member 40 is a member which is attached to the end section on a side opposite to the lid member 36 among the end sections of the photoreceptor drum 35, and is provided with a bearing member 45 and a shaft member 70.

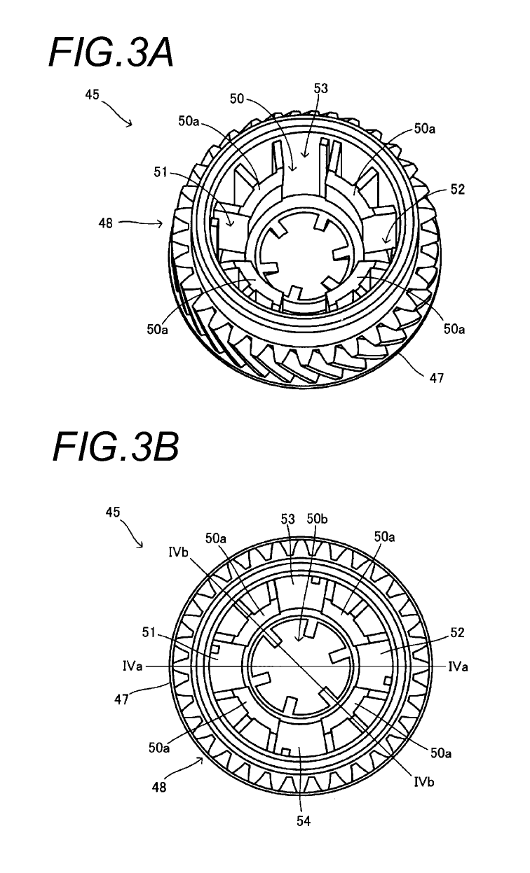

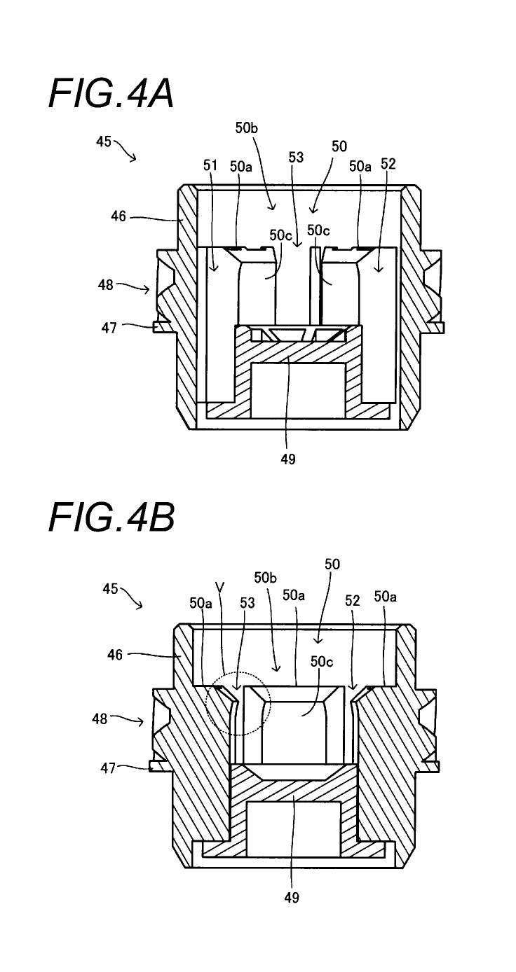

The bearing member 45 is a member which is fixed to the end section of the photoreceptor drum 35. FIG. 3A illustrates a perspective view of the bearing member 45. FIG. 3B is a plan view of the bearing member 45. FIG. 4A illustrates a sectional view along line IVa-IVa of FIG. 3B, and FIG. 4B illustrates a sectional view along line IVb-IVb of FIG. 3B.

In the embodiment, as can be ascertained from FIGS. 2A to 4B, the bearing member 45 is provided with a tubular body 46 which has a cylindrical shape. In addition, on an outer circumferential surface of the tubular body 46, a contact wall 47 which has a shape of a ring that stands along the outer circumferential surface, and a gear 48 are formed. An outer diameter of the tubular body 46 is generally the same as an inner diameter of the photoreceptor drum 35, and the bearing member 45 is fixed to the photoreceptor drum 35 by putting one end side of the tubular body 46 into the photoreceptor drum 35 and making the one end side fit to the photoreceptor drum 35. At this time, the end surface of the photoreceptor drum 35 is inserted until the end surface reaches a part having a depth at which the end surface abuts the contact wall 47. At this time, an adhesive may be used for more solid fixing. In addition, a groove or a bumpy part may be provided in the tubular body 46 of a part where the adhesive is disposed. Accordingly, the adhesive is held in the groove or a concave section, and further, solid adhesion between the photoreceptor drum 35 and the bearing member 45 is possible.

The gear 48 is a gear which transmits the rotating force to a developing roller, and is a helical gear. A type of the gear is not particularly limited, and may be a spur gear. However, the gear is not necessarily provided.

A bottom section 49 is attached to a tubular inner side of the tubular body 46 to block the inside of the tubular body 46. The bottom section 49 is configured to be attachable to and detachable from the tubular body 46, and is disengaged from the tubular body 46 when a predetermined force is applied in the axial direction in a state where the bottom section 49 is mounted on the tubular body 46 as illustrated in FIGS. 4A and 4B.

Furthermore, inside the tubular body 46 divided by the bottom section 49, a holding section 50 is provided on the inner opposite to a side which is fixed to the photoreceptor drum 35. The bottom section 49 and the tubular body 46 are bonded to each other by an adhesive, ultrasonic welding, heat welding, caulking, and snap-fitting.

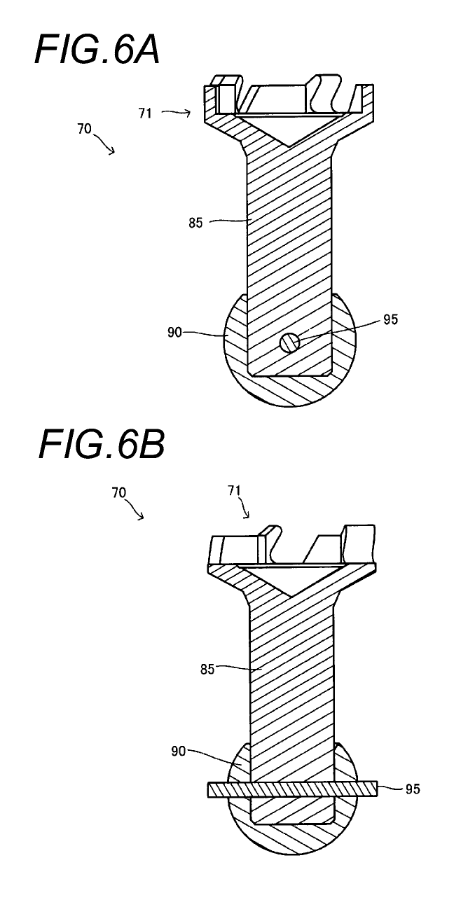

The holding section 50 forms guide grooves 51, 52, 53, and 54 inside the tubular body 46, and holds a spherical body 90 of the shaft member 70 (refer to FIGS. 6A and 6B) inside the bearing member 45. For this reason, in the holding section 50, a plurality of protruding sections 50a are disposed along an inner circumferential surface of the tubular body 46 at a predetermined interval to protrude toward a shaft line of the tubular body 46 from the inner surface of the tubular body 46, and voids between the protruding sections 50a adjacent to each other form the guide grooves 51, 52, 53, and 54. In addition, a space (concave section) 50b is formed at the shaft line part surrounded by the protruding section 50a, and here, a base end section (spherical body 90, refer to FIGS. 6A and 6B) of the shaft member 70 is held as will be described later.

The guide grooves 51, 52, 53, and 54 are grooves which are formed on an inner surface of the tubular body 46 along the axial line direction of the tubular body 46, and two guide grooves which oppose each other while interposing the shaft line of the tubular body 46 therebetween function as one pair. An end section of a rotating force transmission pin 95 of the shaft member 70 is disposed inside the guide grooves 51, 52, 53, and 54 as will be described later, and the rotating force transmission pin 95 is configured to move on the insides of the guide grooves 51, 52, 53, and 54. Therefore, the width of the guide grooves 51, 52, 53, and 54 is generally the same as the diameter of the rotating force transmission pin 95, and accordingly, the guide grooves 51, 52, 53, and 54 are formed to be slightly wider.

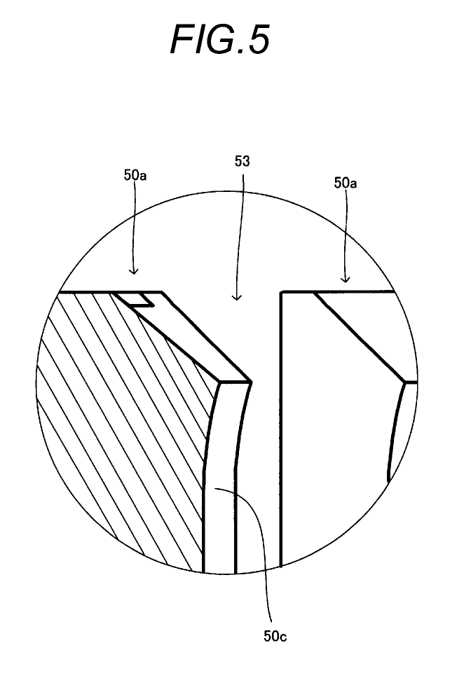

In addition, a surface 50c which configures the concave section 50b in the protruding section 50a has a curved surface so that the interval between the plurality of opposing protruding sections 50a narrows in the end section on the side opposite to the bottom section 49, as can be ascertained from FIGS. 4A and 4B. FIG. 5 is an enlarged view of a part illustrated with V in FIG. 4B. Here, the curved surface of the surface 50c of the protruding section 50a is illustrated well. Due to the curved surface in which the interval narrows, the spherical body 90 of the shaft member 70 is hooked here, and the shaft member 70 is held to be prevented from falling out from the bearing member 45, as will be described later. It is preferable that the curved surface has a radius of curvature which becomes the same as a radius of a spherical surface of the spherical body 90.

A material which configures the bearing member 45 is not particularly limited, but a resin made of polyacetal, polycarbonate, or PPS can be used. Here, in order to improve rigidity of the member, glass fibers, carbon fibers, or the like, may be mixed in the resin in accordance with a loading torque. In addition, in order to attach the shaft member to the bearing member and smoothly perform a swinging operation, sliding properties may be improved by containing at least one of fluorine, polyethylene, and silicon rubber in the resin. In addition, the resin may be coated with fluorine, and may be coated with a lubricant.

Returning to FIG. 2B, the shaft member 70 in the end member 40 will be described. Respectively, FIG. 6A illustrates a sectional view along line VIa-VIa of the shaft member 70 illustrated in FIG. 2B, and FIG. 6B illustrates a sectional view along line VIb-VIb of the shaft member 70 illustrated in FIG. 2B. As can be ascertained from FIGS. 2A, 2B, 6A, and 6B, the shaft member 70 is provided with a coupling member 71, a rotating shaft 85, a spherical body 90, and the rotating force transmission pin 95.

The rotating shaft 85 is a columnar shaft-like member which functions as a rotating force transmission section for transmitting the rotating force that the coupling member 71 receives. Therefore, the coupling member 71 is provided on one end of the rotating shaft 85. In addition, the spherical body 90 is disposed on the other end.

The coupling member 71 is a part which functions as a rotating force receiving section which receives a rotational driving force from the apparatus body 10 (refer to FIG. 1). As can be ascertained from FIGS. 6A and 6B, the coupling member is in a state of being engaged with the drive shaft from the apparatus body 10, and is formed to have a diameter greater than that of the rotating shaft 85 on one end side of the rotating shaft 85.

The spherical body 90 functions as a base end section, and in the embodiment, as can be ascertained from FIGS. 6A and 6B, the spherical body 90 is a spherical member, and is provided in the end section on the side opposite to the side on which the coupling member 71 is disposed among the end sections of the rotating shaft 85. At this time, it is preferable that the center of the spherical body 90 is disposed on the shaft line of the rotating shaft 85. Accordingly, it is possible to obtain a more stable rotation of the photoreceptor drum 35.

In addition, the radius of the spherical body 90 is generally the same as the radius of the curvature of the above-described concave section 50b which is formed in the holding section 50 of the bearing member 45. As will be described later, when the shaft member 70 is attached to the bearing member 45, the movement of the spherical body 90 in a direction of being removed from the shaft member 70 is regulated by the holding section 50 of the bearing member 45.

In the embodiment, a case where a normal spherical shape is used as the base end section is illustrated, but the invention is not limited thereto, and for example, a case of a partial spherical shape, or a case where oval-shaped curved surfaces having different radius of curvature from each other are combined, may be employed.

The rotating force transmission pin 95 is a columnar shaft-like member which passes through the center of the spherical body 90, and in which both ends are disposed to protrude from the spherical body 90 through the spherical body 90. The shaft line of the rotating force transmission pin 95 is provided to be orthogonal to the shaft line of the rotating shaft 85.

A material of the shaft member 70 is not particularly limited, but a resin made of polyacetal, polycarbonate, or PPS can be used. However, in order to improve rigidity of the member, glass fibers, carbon fibers, or the like, may be mixed in the resin in accordance with a loading torque. In addition, rigidity may be further improved by inserting metal into the resin, or the entire member may be made of metal.

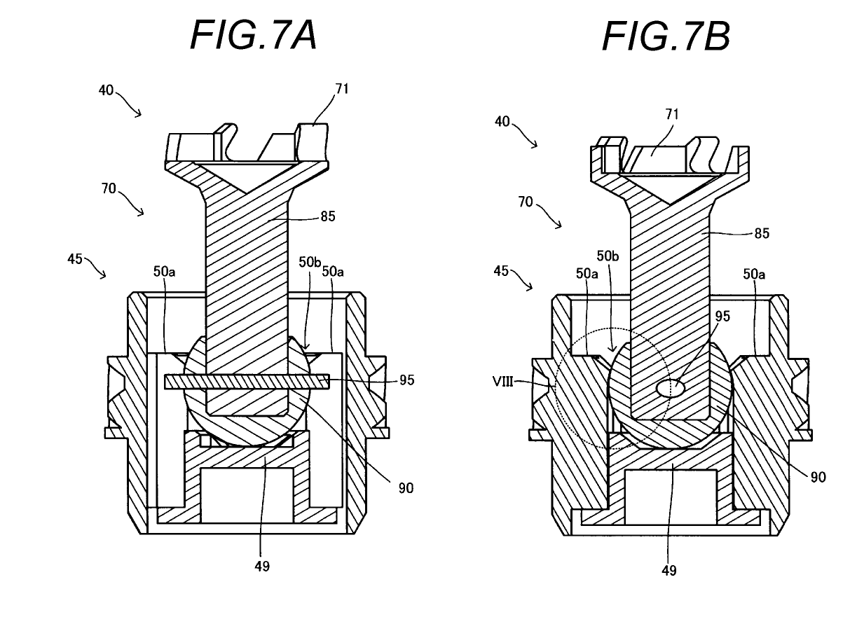

By attaching the shaft member 70 to the bearing member 45 as follows, the end member 40 is made. Respectively, FIG. 7A is a sectional view in a direction along the shaft line of the end member 40 along line illustrated with IVa-IVa in FIG. 3B in a posture in which the shaft member 70 is attached to the bearing member 45, and similarly, FIG. 7B is a sectional view in a direction along the shaft line of the end member 40 along line illustrated with IVb-IVb.

As can be ascertained from FIGS. 7A and 7B, the spherical body 90 of the shaft member 70 is disposed inside the space by the concave section 50b of the holding section 50. At this time, both end sections of the rotating force transmission pin 95 which protrude from the spherical body 90 are respectively inserted into the guide grooves 51 and 52. Accordingly, the coupling member 71 is disposed to protrude from the bearing member 45.

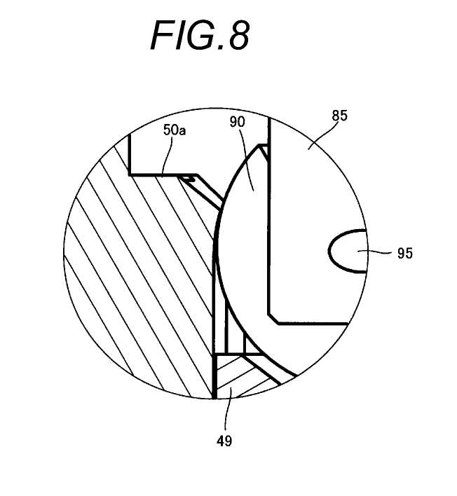

Meanwhile, when the spherical body 90 is disposed inside the concave section 50b, the spherical body 90 is engaged with a part at which the interval of the plurality of opposing protruding sections 50a narrows, and the spherical body 90 is held not to come off from the bearing member 45. FIG. 8 illustrates an enlarged view of a part illustrated with VIII in FIG. 7B. In this manner, the shaft member 70 is held by the bearing member 45 as the spherical body 90 is nipped between the protruding sections 50a, and is hooked to a part at which the interval between the protruding sections 50a narrows.

In this manner, as the shaft member 70 is disposed inside the bearing member 45, the shaft member 70 can rotate (swing) around the shaft line of the rotating force transmission pin 95. Furthermore, the shaft member 70 can also rotate (swing) in a direction in which the shaft line itself of the rotating force transmission pin 95 swings. This is possible because both end sections of the rotating force transmission pin 95 respectively move in the guide grooves 51 and 52.

In addition, when receiving the driving force from the apparatus body 10, in the posture illustrated in FIGS. 2A, 2B, 7A, and 7B, the shaft member 70 receives the rotating force around the shaft line thereof. At this time, both end sections of the rotating force transmission pin 95 of the shaft member 70 can be hooked to groove side surfaces (groove side walls) of the guide grooves 51 and 52, and transmit the rotating force to the bearing member 45, and then, to the photoreceptor drum 35.

In the end member 40, in detaching the shaft member 70 from the bearing member 45 because of such reasons as reusing, it is necessary to release the engagement of the spherical body 90 which is engaged with the holding section 50 and detach the shaft member 70. According to the technology described in U.S. Pat. No. 7,885,575 as described above, the shaft member 70 comes off by grabbing the coupling member 71 having a large diameter and forcibly pulling the coupling member 71. However, there is a concern that this method causes scratches or damage particularly to the coupling member 71 of the shaft member 70 as described above, and it is not possible to say that efficiency is excellent from the viewpoint of production.

In contrast to this, in the present invention, there is provided a method having excellent efficiency from the viewpoint of productivity without damaging the coupling member 71.

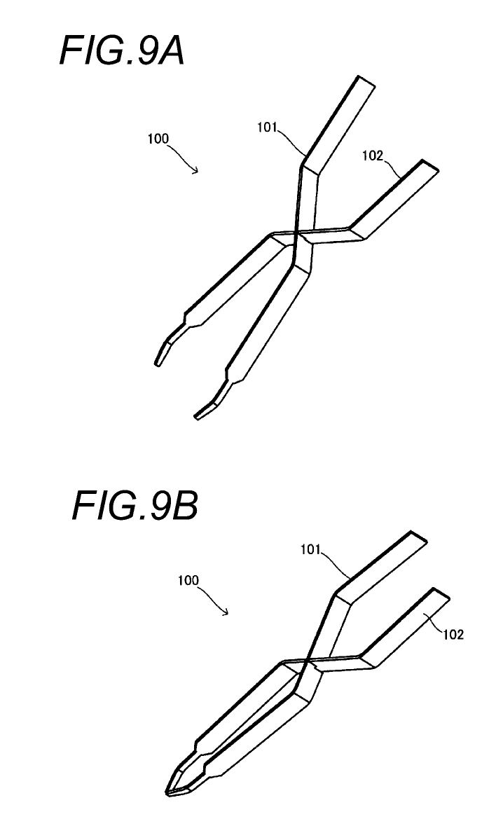

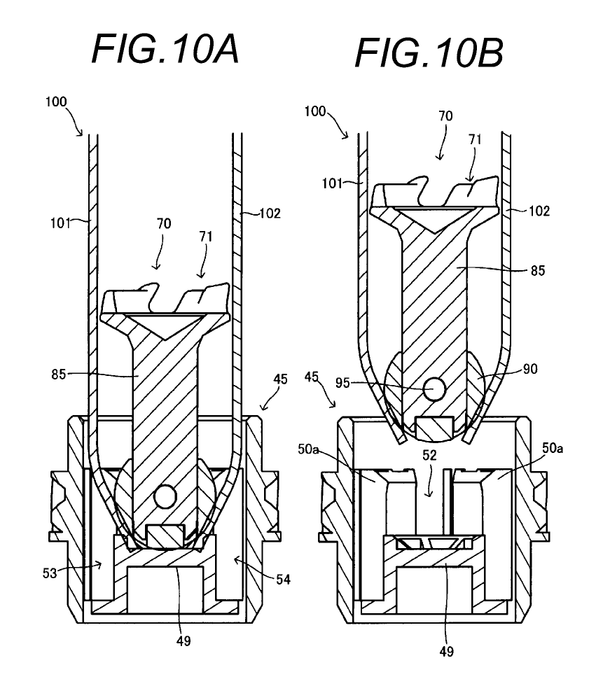

FIGS. 9A to 10B are diagrams illustrating a first embodiment. Respectively, FIG. 9A is a perspective view illustrating one posture of a tool 100 which is used in the first embodiment, and FIG. 9B is a perspective view illustrating another posture of the tool 100. FIG. 10A is a sectional view illustrating a situation in which the spherical body 90 is grabbed by the tool 100, and FIG. 10B is a sectional view illustrating a situation in which the shaft member 70 is detached from the bearing member 45.

In the tool 100, two elongated plate-shaped members 101 and 102 intersect with each other at the substantial center in a longitudinal direction thereof, and can rotate around there. Here, the members 101 and 102 which have a shape of a plate are disposed so that one plate surface faces the other, and the width of the plate of one tip end becomes narrow. It is preferable that the narrowed width of the plate of the tip end is slightly smaller than the guide grooves 51, 52, 53, and 54. Accordingly, it is possible to put the tool 100 into the guide grooves 51, 52, 53, and 54, as will be described later.

In addition, the tip ends of which the width of the plate is narrowed are bent to approach each other.

According to the tool 100, the posture illustrated in FIG. 9A and the posture illustrated in FIG. 9B are possible, and for example, it is possible to operate the end section by holding the end section on a side opposite to a side on which the members 101 and 102 are thinly formed by hand.

By using the tool 100, for example, it is possible to detach the shaft member 70 from the bearing member 45 as follows. In other words, first, as illustrated in FIG. 10A, the end section side which is thinly formed in the tool 100 is inserted to each of the guide grooves (in this example, the guide grooves 53 and 54) in which the rotating force transmission pin 95 is not disposed among the guide grooves. Accordingly, as illustrated in FIG. 10A, the tip end of the tool 100 is disposed to nip the spherical body 90. Next, a force is applied in a direction in which the tip end of the tool 100 narrows, the spherical body 90 is nipped and held by the tip end, and as illustrated in FIG. 10B, the spherical body 90 is pulled out from the bearing member 45. At this time, a part of the spherical body 90 and the protruding section 50a is elastically deformed by a pulling-out force, and the engagement of the spherical body 90 and the protruding section 50a is released, and the shaft member 70 can be detached from the bearing member 45.

In the embodiment, a force acts on the spherical body of the shaft member, and the shaft member is detached from the bearing member. Accordingly, the coupling member 71 is not damaged. In addition, by using the tool, it is possible to efficiently detach the shaft member from the viewpoint of a force and a grabbing position when grabbing the shaft member.

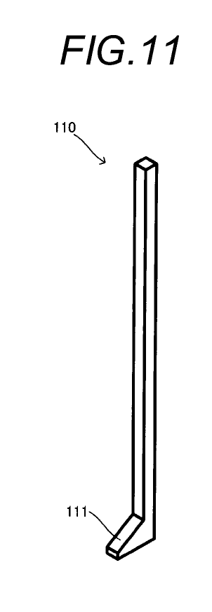

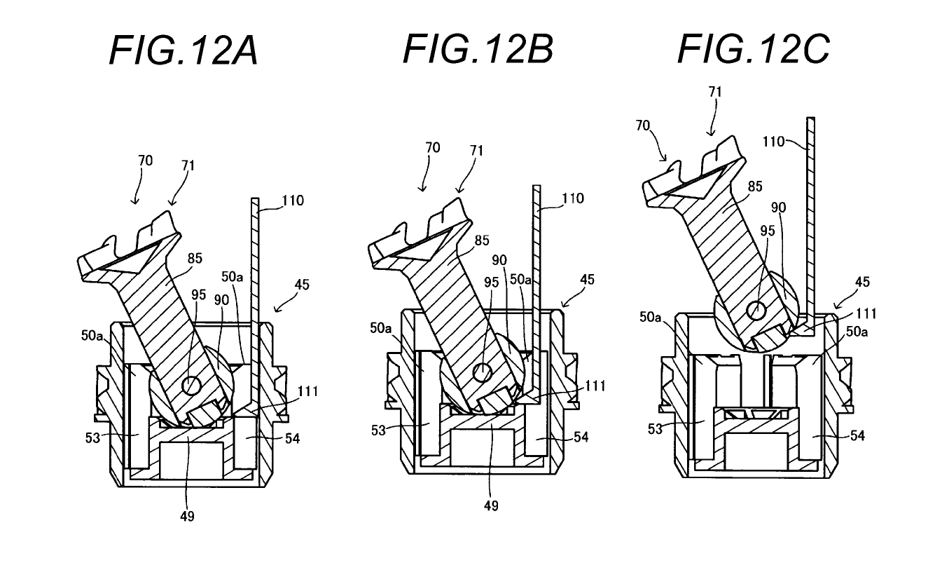

FIGS. 11 and 12A to 12C are diagrams illustrating a second embodiment. FIG. 11 is a perspective view of an external appearance of a tool 110 which is used in the second embodiment. FIG. 12A is a sectional view illustrating a situation in which the tool 110 is put into the bearing member 45. FIG. 12B is a sectional view illustrating a situation in which the tool 110 is put into the bottom section of the spherical body 90 of the shaft member 70. FIG. 12C is a sectional view illustrating a situation in which the shaft member 70 is detached from the bearing member 45 by the tool 110.

The tool 110 is an elongated bar-like member, a bar-like hook section 111 which protrudes to be perpendicular to the longitudinal direction is provided at one tip end. The hook section 111 is not particularly limited if the section protrudes in this manner. However, it is preferable that the hook section 111 is formed to become thin toward the tip end as illustrated in the example. Accordingly, along the spherical body 90, it is possible to detach the shaft member 70 from the bearing member 45 more efficiently.

In addition, it is preferable that the tool 110 is slightly thinner than the guide grooves 51, 52, 53, and 54. Accordingly, it is possible to put the tool 110 into the guide grooves 51, 52, 53, and 54 as will be described later.

By using the tool 110, for example, it is possible to detach the shaft member 70 from the bearing member 45.

In other words, first, as illustrated in FIG. 12A, an end section on a side on which the hook section 111 is formed in the tool 110 is inserted to any of the guide grooves (in this example, the guide grooves 53 and 54) on which the rotating force transmission pin 95 is not disposed. At this time, the side on which the hook section 111 protrudes is toward the spherical body 90. Accordingly, as illustrated in FIG. 12A, the hook section 111 is disposed at a position between the bottom section of the spherical body 90 and the bottom section 49.

Next, as illustrated in FIG. 12B, the hook section 111 of the tool 110 is put between the spherical body 90 and the bottom section 49, and hooks the spherical body 90. In addition, as illustrated in FIG. 12C, the tool 110 is pulled up together with the shaft member 70. At this time, a part of the spherical body 90 and the protruding section 50a are elastically deformed by a pulling-up force, the engagement of the spherical body 90 and the protruding section 50a is released, and the shaft member 70 can be detached from the bearing member 45.

Even in the embodiment, a force acts on the spherical body of the shaft member, and the shaft member is detached from the bearing member. Therefore, according to this, the coupling member 71 is not damaged. In addition, by using the tool, it is possible to efficiently detach the shaft member from the viewpoint of the pulling-up force.

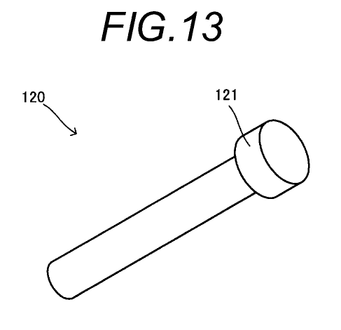

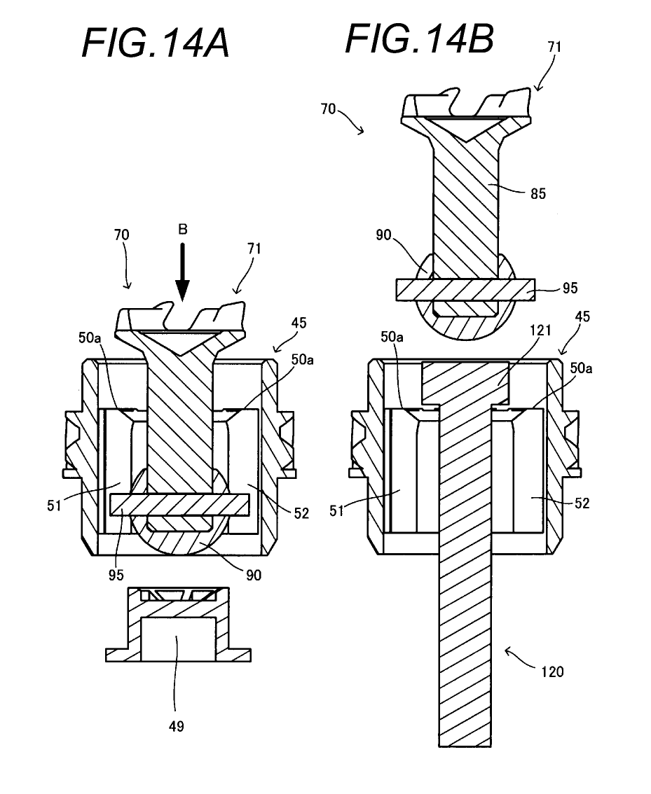

FIGS. 13, 14A and 14B are diagrams illustrating a third embodiment. FIG. 13 is a perspective view of an external appearance of a tool 120 which is used in the third embodiment. FIG. 14A is a sectional view illustrating one situation of a procedure of detaching the shaft member 70 from the bearing member 45 according to the embodiment. FIG. 14B is a sectional view illustrating another situation of a procedure of detaching the shaft member 70 from the bearing member 45 according to the embodiment.

The tool 120 is an elongated bar-like member, and is provided with an expansion section 121 which is largely formed at one tip end thereof. However, it is not necessary that the expansion section 121 is always provided. In addition, it is preferable that the tool 120 is thinner than a diameter of the spherical body 90. Accordingly, as will be described later, it is possible to put the tool 120 into the tubular body 46, and to press the spherical body 90.

By using the tool 120, for example, it is possible to detach the shaft member 70 from the bearing member 45 as follows.

In other words, first, as illustrated with an arrow B in FIG. 14A, a force is applied to the shaft member 70 to press the bottom section 49. At this time, by pressing a shaft line section of the coupling member 71, it is possible to avoid the coupling member 71 from being damaged. Accordingly, as illustrated in FIG. 14A, the bottom section 49 comes off from the tubular body 46, and the spherical body 90 is exposed at the part where the bottom section 49 comes off.

Next, as illustrated in FIG. 14B, it is possible to push the spherical body 90 in which the expansion section 121 of the tool 120 is exposed, and to disengage the shaft member 70 from the bearing member 45 by pressing the spherical body 90 in the axial line. At this time, a part of the spherical body 90 and the protruding section 50a is elastically deformed by a pressing force, the engagement of the spherical body 90 and the protruding section 50a is released, and the shaft member 70 can be detached from the bearing member 45.

In the embodiment, the shaft member is detached from the bearing member by decomposing a part of the end member 40 and making a force act on the spherical body of the shaft member. Therefore, according to this, the coupling member 71 is not damaged. In addition, by using the tool, it is possible to efficiently detach the shaft member by using the tool.

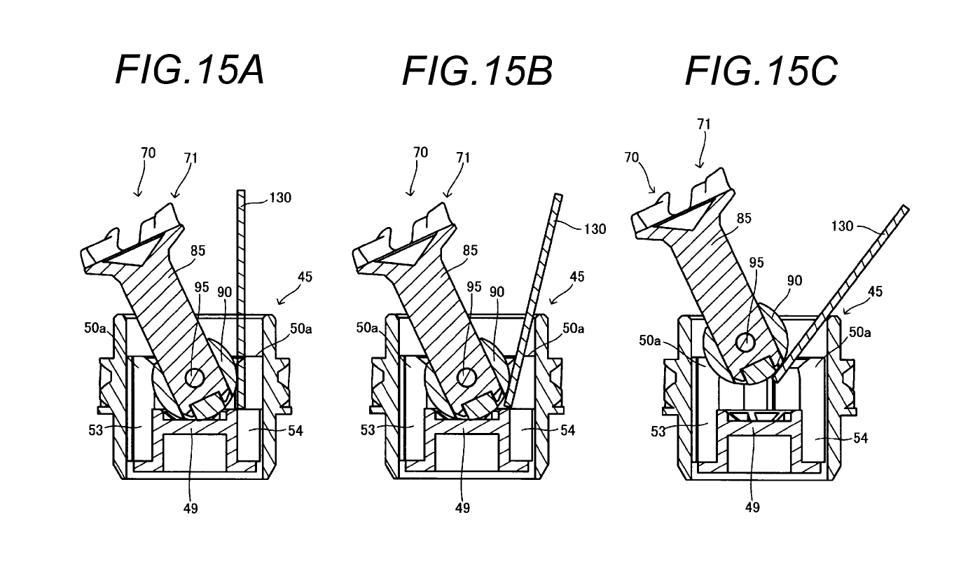

FIGS. 15A to 15C are diagrams illustrating a fourth embodiment. FIG. 15A is a sectional view illustrating a situation in which a tool 130 is put into the bearing member 45. FIG. 15B is a sectional view illustrating a situation in which one end section of the tool 130 is hooked to the spherical body 90 of the shaft member 70. FIG. 15C is a sectional view illustrating a situation in which the shaft member 70 is detached from the bearing member 45 by the tool 130.

The tool 130 is an elongated bar-like member. In addition, it is preferable that the tool 130 is slightly thinner than the guide grooves 51, 52, 53, and 54. Accordingly, it is possible to put the tool 130 into the guide grooves 51, 52, 53, and 54. In addition, it is possible to use a shape similar to the above-described tool 110 as the tool 130.

By using the tool 130, for example, it is possible to detach the shaft member 70 from the bearing member 45 as follows.

In other words, first, as illustrated in FIG. 15A, one end section of the tool 130 is inserted into any of the guide grooves (in this example, the guide grooves 53 and 54) in which the rotating force transmission pin 95 is not disposed among the guide grooves. Accordingly, as illustrated in FIG. 15A, one inserted end section is disposed in the vicinity of the bottom section of the spherical body 90.

Next, as illustrated in FIG. 15B, the other end section of the tool 130 moves to be separated from the shaft member 70. Accordingly, a part in the middle of the tool 110 comes into contact with an edge of the tubular body 46, and accordingly, the tool 130 acts as a “lever” having a part which comes into contact with the edge as a fulcrum, the other end section as leverage, and one end section as a point of application. Therefore, when the other end section is further moved to be separated from the shaft member 70, one end section of the tool 130 presses the spherical body 90 as illustrated in FIG. 15C, and the shaft member 70 can be detached from the bearing member 45.

Even in the embodiment, a force acts on the spherical body of the shaft member, and the shaft member is detached from the bearing member. Therefore, according to this, the coupling member 71 is not damaged. In addition, by using the tool, it is possible to efficiently detach the shaft member from the viewpoint of the pulling-up force.

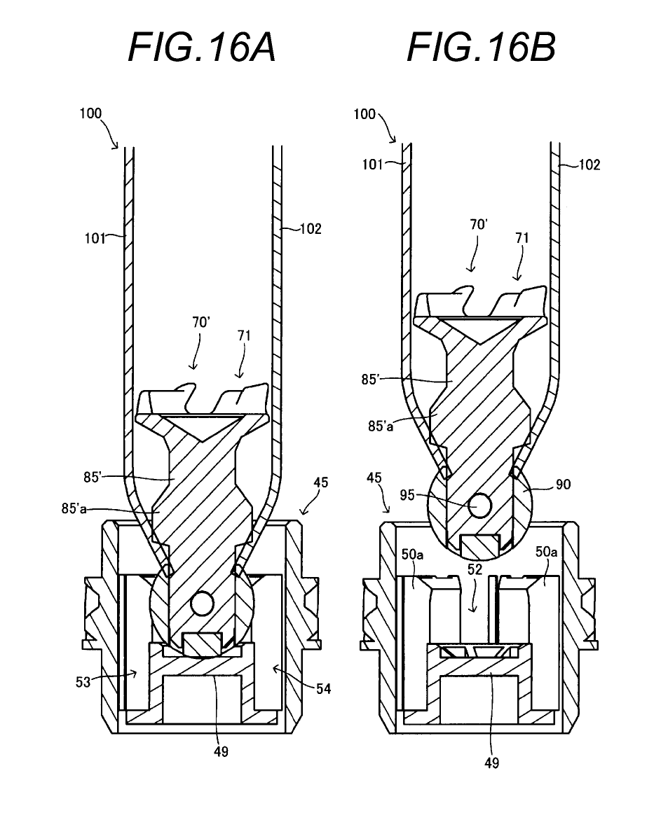

FIGS. 16A to 18B are diagrams illustrating another example of detaching the shaft member. In another example, a shaft member 70′ is provided with an expansion section 85′a which is formed to have a large diameter on a rotation shaft thereof. Hereinafter, the expansion section 85′a is used in a detaching direction of the shaft member 70′ which will be described below.

In the example illustrated in FIGS. 16A and 16B, the above-described tool 100 is used. FIG. 16A is a sectional view illustrating a situation in which the expansion section 85′a is grabbed by the tool 100. FIG. 16B is a sectional view illustrating a situation in which the shaft member 70′ is detached from the bearing member 45.

By using the tool 100, for example, it is possible to detach the shaft member 70′ from the bearing member 45 as follows. In other words, first, as illustrated in FIG. 16A, an end section on a thinly formed side in the tool 100 is hooked to an end section of the expansion section 85′a. In addition, by applying a force in a direction in which the tip end of the tool 100 narrows, the expansion section 85′a is nipped and held by the tip end, and as illustrated in FIG. 16B, the expansion section 85′a is pulled out from the bearing member 45. At this time, a part of the spherical body 90 and the protruding section 50a is elastically deformed by the pulling-out force, the engagement of the spherical body 90 and the protruding section 50a is released, and the shaft member 70′ can be detached from the bearing member 45.

In the example, a force acts on the expansion section 85′a of the shaft member 70′, and the shaft member is detached from the bearing member. Accordingly, the coupling member 71 is not damaged. In addition, by using the tool, it is possible to efficiently detach the shaft member from the viewpoint of a force and a grabbing position when grabbing the expansion section 85′.

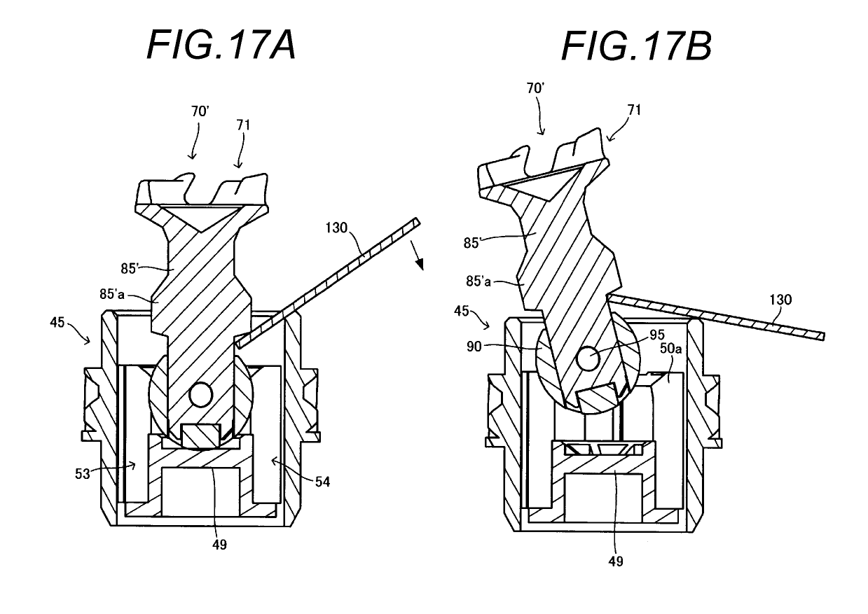

The example illustrated in FIGS. 17A and 17B uses the above-described tool 130. FIG. 17A is a sectional view illustrating a situation in which one end section of the tool 130 is hooked to the expansion section 85′a. FIG. 17B is a sectional view illustrating a situation in which the shaft member 70′ is detached from the 45.

By using the tool 130, for example, it is possible to detach the shaft member 70′ from the bearing member 45 as follows.

In other words, first, as illustrated in FIG. 17A, one end section of the tool 130 is hooked to the expansion section 85′a, a part in the middle of the tool 110 comes into contact with the edge of the tubular body 46, and further, the other end section of the tool 130 is disposed on the outer side. Accordingly, the tool 130 acts as a “lever” having a part which comes into contact with the edge as a fulcrum, the other end section as leverage, and one end section as a point of application. Therefore, when the other end section is further moved as illustrated with a straight arrow in FIG. 17A, one end section of the tool 130 presses up the expansion section 85′a as illustrated in FIG. 17B, and the shaft member 70′ can be detached from the bearing member 45.

Even in the example, a force acts on the expansion section 85′a of the shaft member 70′, and the shaft member is detached from the bearing member. Accordingly, the coupling member 71 is not damaged. In addition, by using the tool, it is possible to efficiently detach the shaft member from the viewpoint of applying manner of a force to the shaft member.

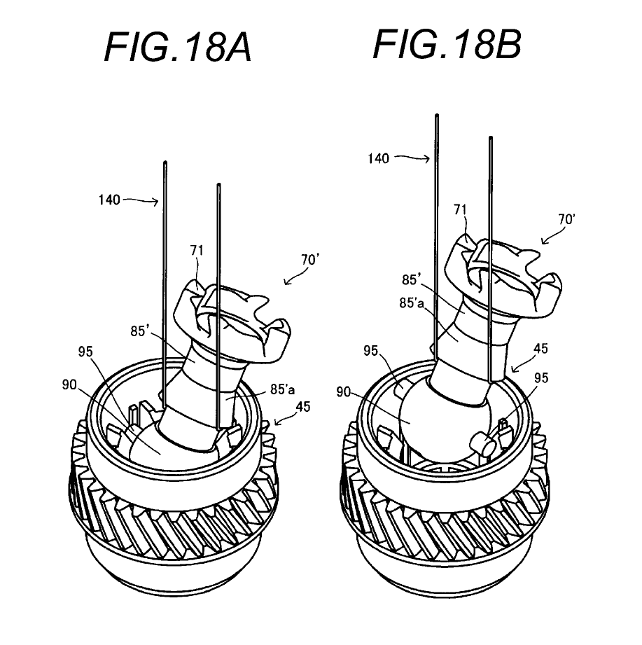

The example illustrated in FIGS. 18A and 18B uses a wire 140. FIG. 18A is a perspective view of an external appearance illustrating one situation of a procedure of detaching the shaft member 70′ from the bearing member 45. FIG. 18B is a perspective view of an external appearance illustrating another situation.

In the example, by using the wire 140 as a line material, it is possible to detach the shaft member 70′ from the bearing member 45.

As can be ascertained from FIG. 18A, the wire 140 is wound around the expansion section 85′a. In addition, as illustrated in FIG. 18B, by pulling up the wire 140, the shaft member 70′ is detached from the bearing member 45. At this time, a part of the spherical body 90 and the protruding section 50a is elastically deformed by the pulling-up force, the engagement of the spherical body 90 and the protruding section 50a is released, and the shaft member 70′ can be detached from the bearing member 45.

Even in the example, a force acts on the expansion section of the shaft member, and the shaft member is detached from the bearing member. Accordingly, the coupling member 71 is not damaged. In addition, by using the tool, it is possible to efficiently detach the shaft member.

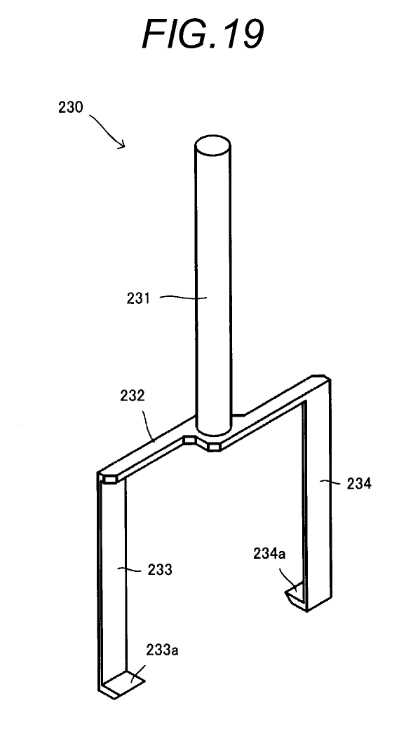

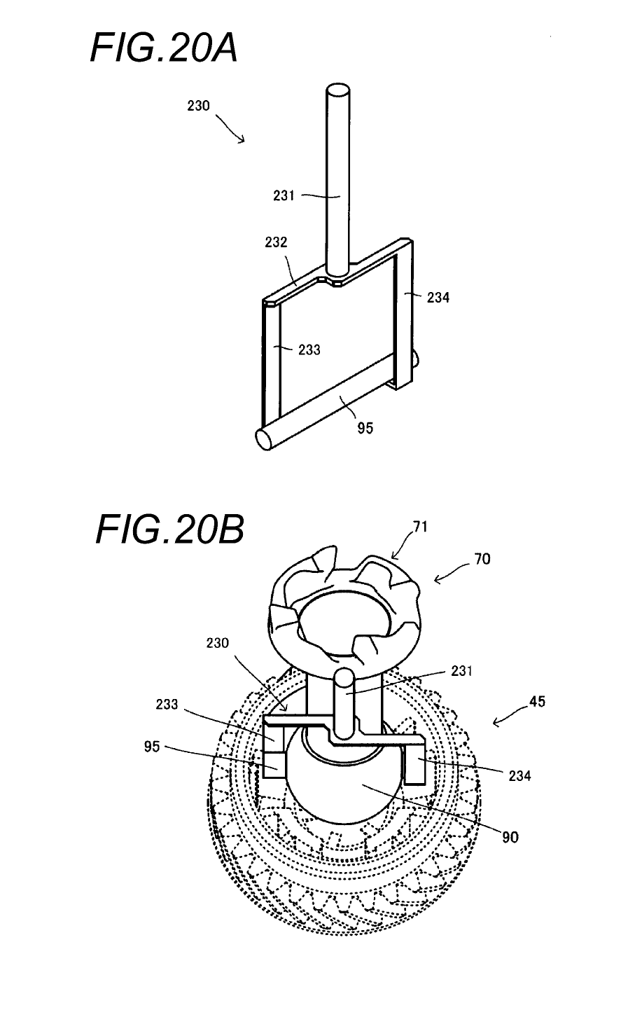

FIGS. 19, 20A and 20B are diagrams illustrating a fifth embodiment. FIG. 19 is a perspective view of an external appearance of a tool 230 which is used in the fifth embodiment. FIG. 20A is a perspective view illustrating that rotating force transmission pin 95 is held by the tool 230. FIG. 20B is a perspective view illustrating a situation in which the shaft member 70 is detached from the bearing member 45. FIG. 20B illustrates the bearing member 45 with a dashed line.

The tool 230 includes a bar-like operation section 231, and a bar-like extending section 232 which extends to be orthogonal to the longitudinal direction of the operation section 231 is provided at one end of the operation section 231. An end section of the operation section 231 is connected to the substantial center in the longitudinal direction of the extending section 232.

Meanwhile, from each of both ends in the longitudinal direction of the extending section 232, arms 233 and 234 which have a shape of an elongated plate that extends in the direction opposite to the direction in which the operation section 231 extends are disposed, and engagement sections 233a and 234a are formed at tip ends thereof. The engagement sections 233a and 234a protrude from the tip ends of the arms 233 and 234 in a direction which becomes a position of twist with respect to the extending section 232. In addition, it is preferable that the engagement section 233a and the engagement section 234a extend in directions opposite each other.

Here, it is preferable that the width of the plate of the arms 233 and 234 and the engagement sections 233a and 234a is narrower than the depth of the grooves of the guide grooves 51, 52, 53, and 54. Accordingly, it is possible to easily insert the arms 233 and 234 and the engagement sections 233a and 234a into the guide grooves.

By using the tool 230, for example, it is possible to detach the shaft member 70 from the bearing member 45.

According to the tool 230, as conceptually illustrated in FIG. 20A, it is possible to hook, hold, and pull up at least two locations of the bar-like member to embrace from a lower part. At this time, an outer circumferential surface of the bar is held by the arms 233 and 234 and the engagement sections 233a and 234a.

According to an idea similar to this, as illustrated in FIG. 20B, it is possible to detach the shaft member 70 from the bearing member 45 when both ends of the bar-like rotating force transmission pin 95 is held and pulled up by the tool 230. In other words, the arms 233 and 234 may be inserted into the guide grooves into which the rotating force transmission pin 95 is inserted among the guide grooves, and the rotating force transmission pin 95 may be held and lifted up as illustrated in FIG. 20A. At this time, a part of the spherical body 90 and the protruding section 50a is elastically deformed by the pulling-up force, the engagement of the spherical body 90 and the protruding section 50a is released, and the shaft member 70 can be detached from the bearing member 45.

In the embodiment, a force acts on the rotating force transmission pin 95 of the shaft member, and the shaft member is detached from the bearing member. Accordingly, the coupling member 71 is not damaged. In addition, by using the tool, it is possible to efficiently detach the shaft member.

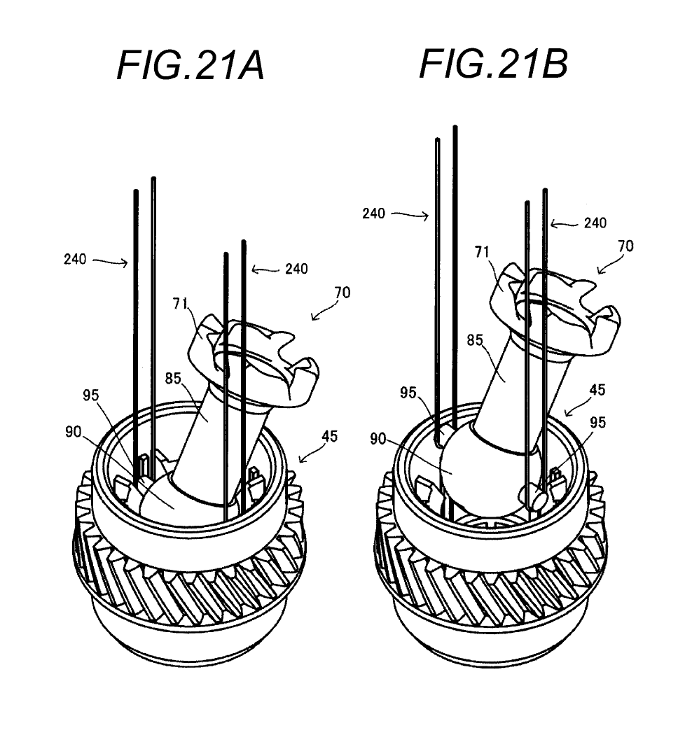

FIGS. 21A and 21B are diagrams illustrating a sixth embodiment. FIG. 21A is a perspective view of an external appearance illustrating one situation of a procedure of detaching the shaft member 70 from the bearing member 45. FIG. 21B is a perspective view of an external appearance illustrating another situation.

In the embodiment, by using wires 240 which are two line members as a tool, it is possible to detach the shaft member 70 from the bearing member 45.

In the embodiment, as can be ascertained from FIG. 21A, the wire 240 is wound around each of the end sections of the rotating force transmission pin 95 protruded from the spherical body 90 at two locations. In addition, as illustrated in FIG. 21B, by pulling up the wire 240, the shaft member 70 is detached from the bearing member 45. At this time, a part of the spherical body 90 and the protruding section 50a is elastically deformed by the pulling-up force, the engagement of the spherical body 90 and the protruding section 50a is released, and the shaft member 70 can be detached from the bearing member 45.

Even in the embodiment, a force acts on the rotating force transmission pin 95 of the shaft member 70, and the shaft member 70 is detached from the bearing member 45. Accordingly, the coupling member 71 is not damaged. In addition, by using the wire, it is possible to efficiently detach the shaft member.

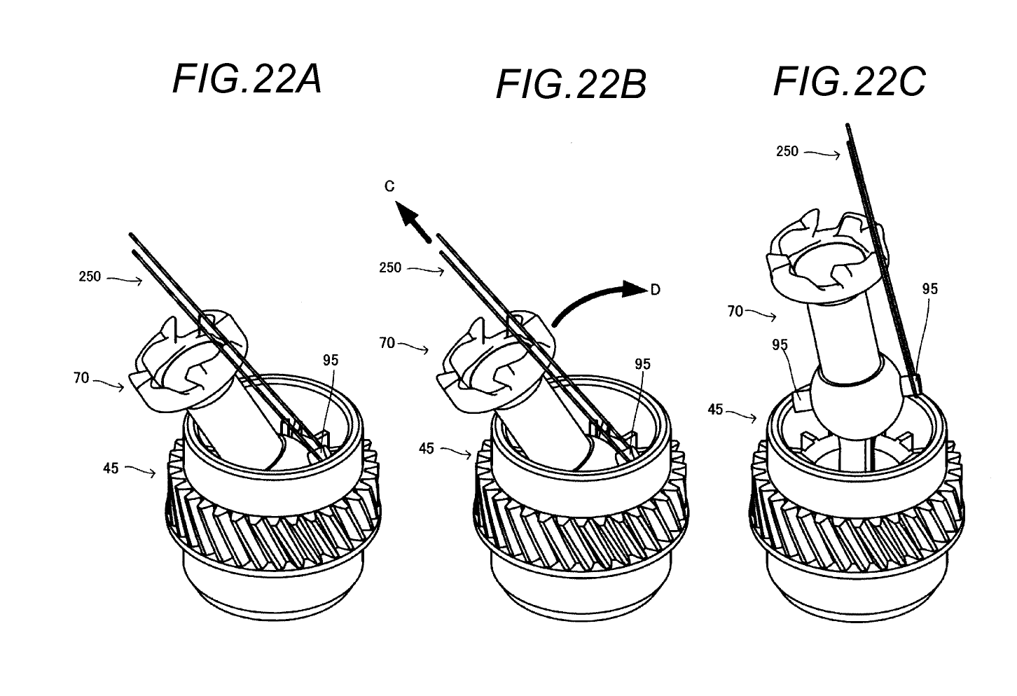

FIGS. 22A to 22C are diagrams illustrating a seventh embodiment. FIG. 22A is a perspective view of an external appearance illustrating one situation of a procedure of detaching the shaft member 70 from the bearing member 45 in the embodiment. FIG. 22B is a perspective view of an external appearance illustrating another situation. FIG. 22C is a perspective view of an external appearance illustrating still another situation.

In the embodiment, by using wire 250 which is one line member as a tool, it is possible to detach the shaft member 70 from the bearing member 45.

In the embodiment, as can be ascertained from FIG. 22A, first, the wire 250 is wound around one of the end sections of the rotating force transmission pin 95 protruded from the spherical body 90 at two locations. In addition, the wire 250 is pulled up in a direction illustrated with an arrow C in FIG. 22B. Accordingly, the shaft member 70 is inclined in a direction in which the shaft member 70 is pulled. In contrast to this, while pulling the wire 250, the shaft member 70 is inclined in a direction reverse to a direction in which the shaft member 70 is inclined as illustrated with an arrow D. Accordingly, as illustrated in FIG. 22C, the rotating force transmission pin 95 on a side which is not wound by the wire 250 is also lifted up, and the shaft member 70 is removed from the bearing member 45. Here, as illustrated with the arrow D, it is preferable to impart the force which makes the shaft member 70 inclined by pressing the rotating shaft 85.

At this time, by the force which pulls up the wire 250, and the force which makes the shaft member 70 inclined, a part of the spherical body 90 and the protruding section 50a is elastically deformed, the engagement of the spherical body 90 and the protruding section 50a is released, and the shaft member 70 can be detached from the bearing member 45.

Even in the embodiment, a force acts on the rotating force transmission pin 95 of the shaft member 70, and the shaft member 70 is detached from the bearing member 45. Accordingly, the coupling member 71 is not damaged. In addition, by using the wire 250, it is possible to efficiently detach the shaft member.

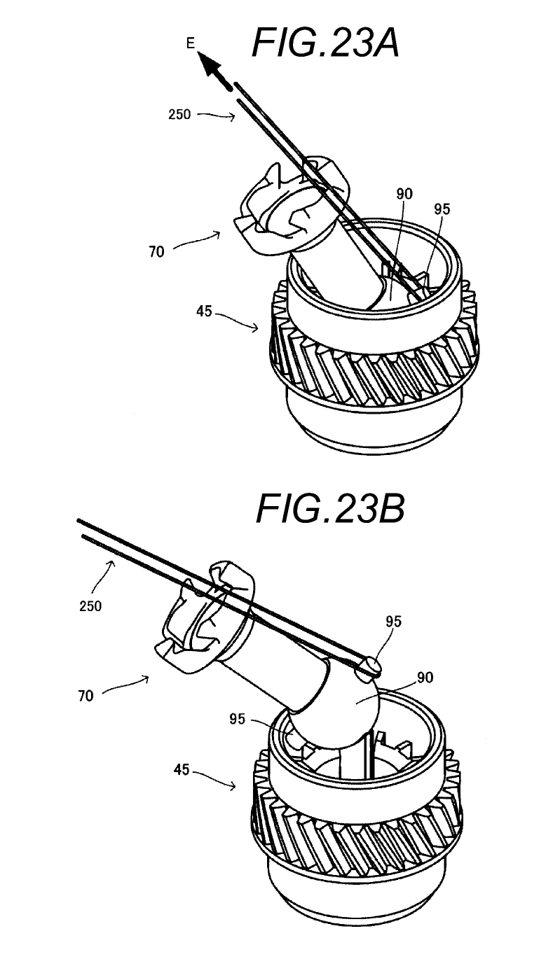

FIGS. 23A and 23B are diagrams illustrating an eighth embodiment. FIG. 23A is a perspective view of an external appearance illustrating one situation of a procedure of detaching the shaft member 70 from the bearing member 45. FIG. 23B is a perspective view of an external appearance illustrating another situation.

Even in the embodiment, by using the wire 250 which is one line member, it is possible to detach the shaft member 70 from the bearing member 45.

Even in the embodiment, as can be ascertained from FIG. 23A, first, the wire 250 is wound around one of the end sections of the rotating force transmission pin 95 protruded from the spherical body 90 at two locations. In addition, the wire 250 is pulled up in a direction illustrated with an arrow E in FIG. 23A. Accordingly, the shaft member 70 is inclined in a direction in which the shaft member 70 is pulled. In contrast to this, in the embodiment, the wire 250 is further pulled in the direction. Then, as illustrated in FIG. 23B, a level of inclination increases as the end section of the rotating force transmission pin 95 on a side which is wound by the wire 250 is further pulled up, and finally, the rotating force transmission pin 95 on a side which is not wound by the wire 250 is also removed from the bearing member 45.

At this time, a part of the spherical body 90 and the protruding section 50a is elastically deformed by the force which pulls up the wire 250, the engagement of the spherical body 90 and the protruding section 50a is released, and the shaft member 70 can be detached from the bearing member 45.

Even in the embodiment, a force acts on the rotating force transmission pin 95 of the shaft member 70, and the shaft member 70 is detached from the bearing member 45. Accordingly, the coupling member 71 is not damaged. In addition, by using the wire 250, it is possible to efficiently detach the shaft member.

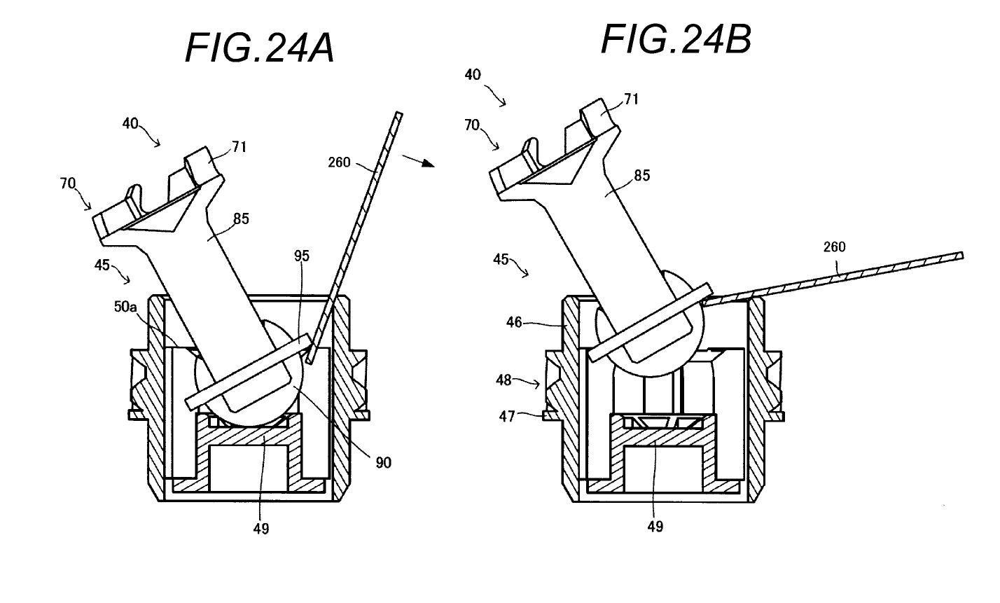

FIGS. 24A and 24B are diagrams illustrating a ninth embodiment. FIG. 24A is a sectional view illustrating a situation in which one end section of a tool 260 is hooked to the rotating force transmission pin 95. FIG. 24B is a sectional view illustrating a situation in which the shaft member 70 is detached from the bearing member 45 by the tool 260.

The tool 260 is an elongated bar-like member. In addition, it is preferable that the tool 260 is slightly thinner than the guide grooves 51, 52, 53, and 54. Accordingly, it is possible to put the tool 260 into the guide grooves 51, 52, 53, and 54.

By using the tool 260, for example, it is possible to detach the shaft member 70 from the bearing member 45 as follows.

In other words, first, as illustrated in FIG. 24A, one end section of the tool 260 is inserted to any of the guide grooves (in the example, the guide grooves 51 and 52) in which the rotating force transmission pin 95 is disposed among the guide grooves. In addition, one end side of the tool 260 is hooked to the rotating force transmission pin 95. Accordingly, a part in the middle of the tool 260 comes into contact with an edge of the tubular body 46, and according to this, the tool 260 acts as a “lever” having a part which comes into contact with the edge as a fulcrum, the other end section as leverage, and one end section as a point of application. Therefore, when the other end section is moved as illustrated with a straight arrow in FIG. 24A, one end section of the tool 260 presses up the rotating force transmission pin 95 as illustrated in FIG. 24B, and the shaft member 70 can be detached from the bearing member 45.

Even in the embodiment, a force acts on the rotating force transmission pin 95 of the shaft member 70, and the shaft member 70 is detached from the bearing member 45. Accordingly, the coupling member 71 is not damaged. In addition, by using the tool 260, it is possible to efficiently detach the shaft member.

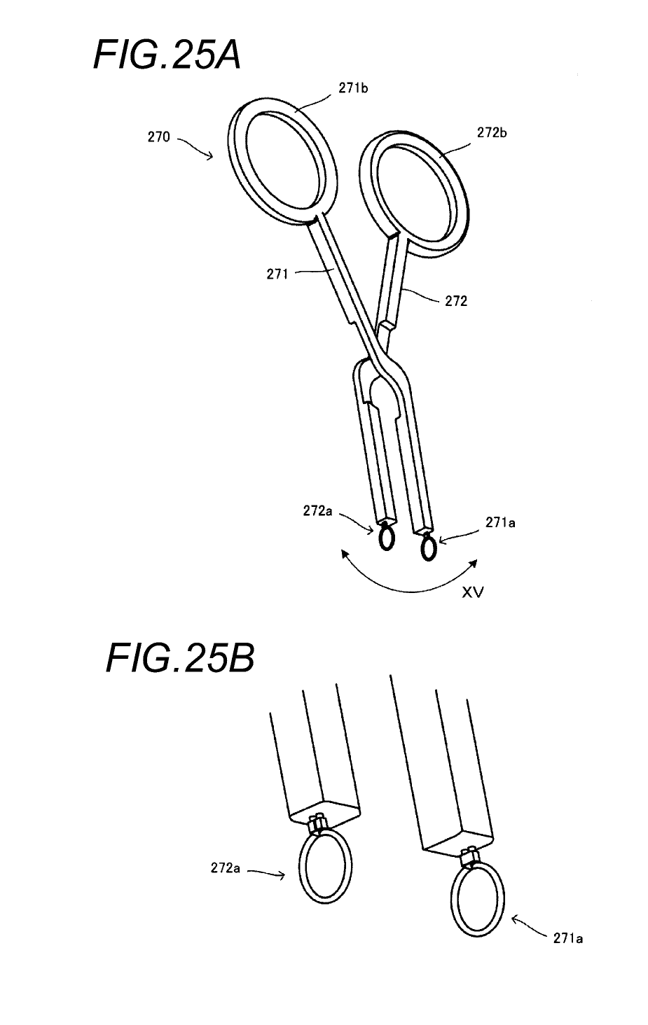

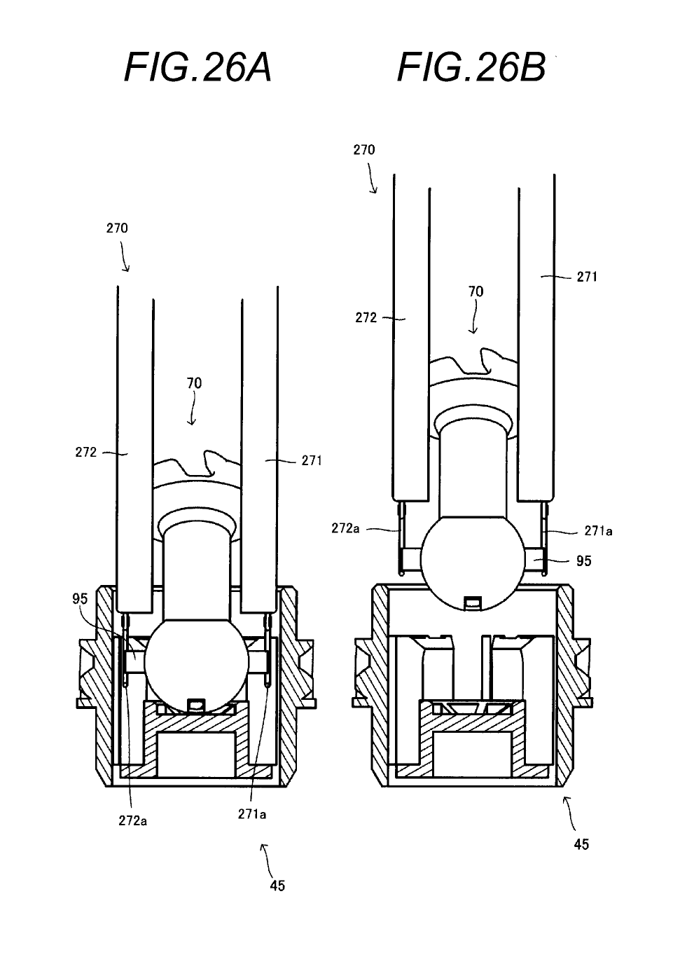

FIGS. 25A to 26B are diagrams illustrating a tenth embodiment. FIG. 25A is a perspective view of a tool 270 which is used in the tenth embodiment. FIG. 25B is an enlarged view of parts of engagement sections 271a and 272a which are disposed at an end section on one side of the tool 270. In addition, FIG. 26A is a sectional view illustrating a situation in which the rotating force transmission pin 95 is hooked and engaged by the tool 270. FIG. 26B is a sectional view illustrating a situation in which the shaft member 70 is detached from the bearing member 45.

In the tool 270, two elongated bar-like members 271 and 272 intersect with each other at the substantial center in the longitudinal direction of the tool 270, and both members 271 and 272 can rotate around here. In addition, the engagement sections 271a and 272a are disposed as illustrated being enlarged in FIG. 25B at the end sections on the sides of each of the members 271 and 272.

In the embodiment, the engagement sections 271a and 272a are circular members, and disposed so that openings thereof face each other. Since the engagement sections 271a and 272a are members which can hook the rotating force transmission pin 95 through the inside thereof as will be described later, the inside thereof has a size and a shape which can insert the rotating force transmission pin 95 therein. In addition, it is preferable that a size of an outer side thereof is slightly smaller than the guide grooves 51, 52, 53, and 54. Accordingly, it is possible to put a tool 270 into the guide grooves 51, 52, 53, and 54 as will be described later.

In addition, in the members 271 and 272, operation sections 271b and 272b are provided at an end section on the other side opposite to an end section on one side on which the engagement sections 271a and 272a are disposed. The end section on the other side is a part where the user operates the tool 270 with the operation sections 271b and 272b, and it is possible to employ an embodiment similar to an operation section of scissors.

According to the tool 270, when the user operates the operation sections 271b and 272b in the same manner as that of scissors, the engagement sections 271a and 272a can approach each other, or can be separated from each other as illustrated with an arrow XV in FIG. 25A.

By using the tool 270, for example, it is possible to detach the shaft member 70 from the bearing member 45 as follows. Namely, first, as illustrated in FIG. 26A, the engagement sections 271a and 272a provided in one end section in the tool 270 are inserted into each of the guide grooves (in the example, the guide grooves 51 and 52) in which the rotating force transmission pin 95 is disposed among the guide grooves. In addition, each of the end sections of the rotating force transmission pin 95 is inserted to the annular inner sides of the engagement sections 271a and 272a.

Next, by operating the operation sections 271b and 272b, and applying a force in a direction in which the end section on one side of the tool 270 narrows, an end section of the rotating force transmission pin 95 is reliably passes through the annular inner side of the engagement sections 271a and 272a. In addition, the shaft member falls out from the bearing member 45 as illustrated in FIG. 26B. At this time, a part of the spherical body 90 and the protruding section 50a is elastically deformed by the pulling-up force, the engagement of the spherical body 90 and the protruding section 50a is released, and the shaft member 70 can be detached from the bearing member 45.

Even in the embodiment, a force acts on the rotating force transmission pin 95 of the shaft member 70, and the shaft member 70 is detached from the bearing member 45. Accordingly, the coupling member 71 is not damaged. In addition, by using the tool 270, it is possible to efficiently detach the shaft member.

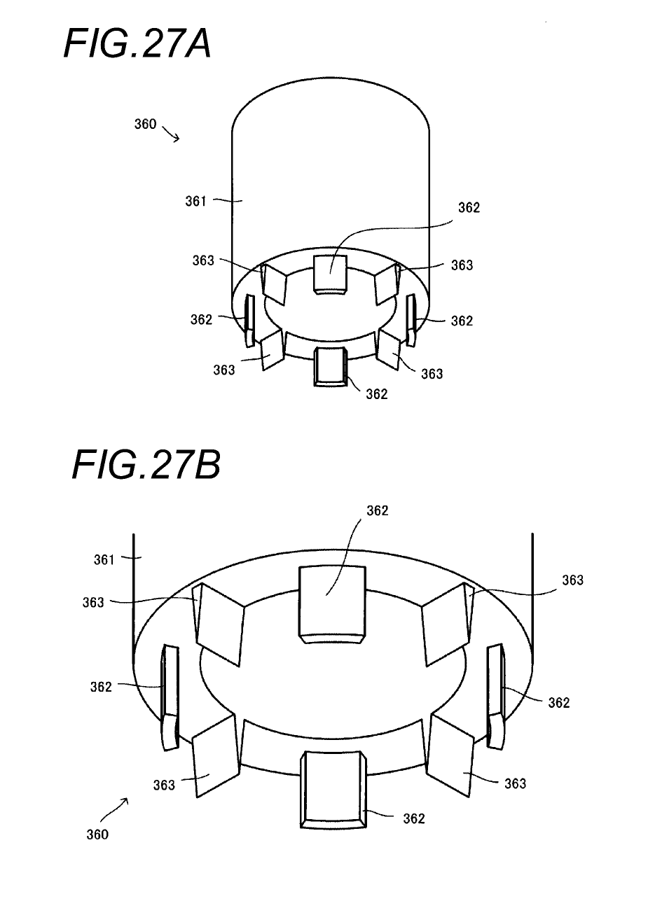

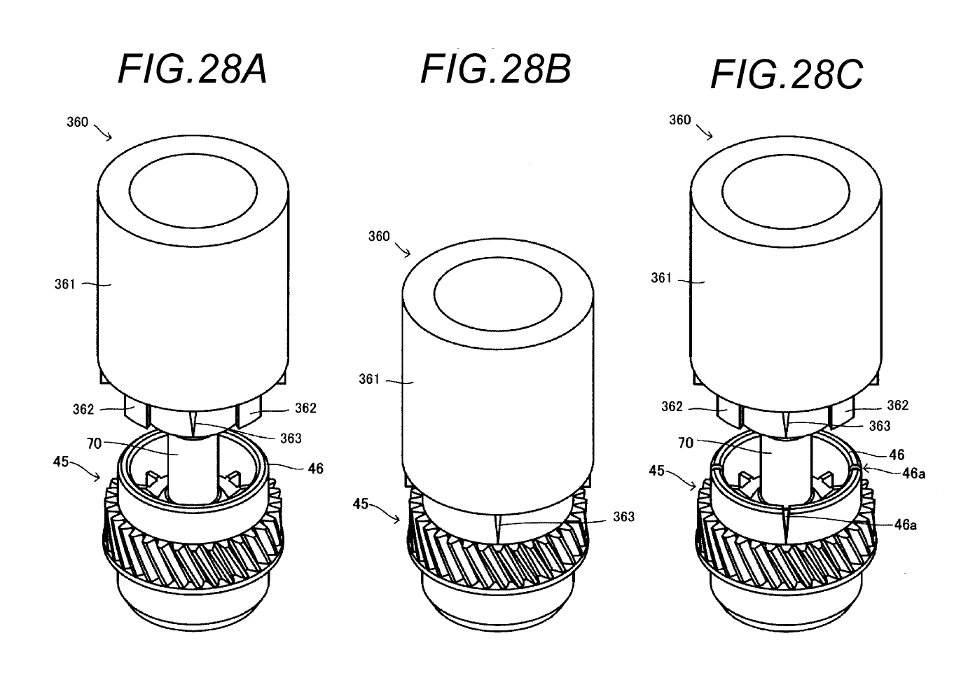

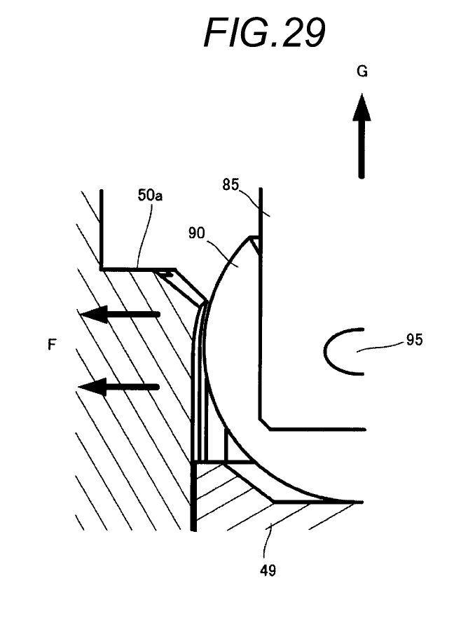

FIGS. 27A to 29 are diagrams illustrating an eleventh embodiment. The embodiment is an example in which the shaft member is taken out by the deformation which is accompanied by damage of the bearing member. FIG. 27A is a perspective view of an external appearance of a tool 360 which is used in the eleventh embodiment. FIG. 27B is an enlarged perspective view of a part of the tool 360. FIG. 28A is a perspective view of an external appearance illustrating one situation of a procedure of detaching the shaft member 70 from the bearing member 45. FIG. 28B is a perspective view of an external appearance illustrating the other situation. FIG. 28C is a perspective view of an external appearance illustrating still another situation. FIG. 29 illustrates an enlarged view illustrating a procedure of detaching the shaft member 70 from the bearing member 45 in the embodiment.

The tool 360 has a cylindrical body 361. A guide 362 and a notching blade 363 stand from one end surface of the cylindrical body 361. Here, since the shaft member 70 is inserted into a tubular inner side of the body 361 in a procedure of detaching the shaft member 70, a diameter of the inside of the body 361 has a size which can insert the coupling member 71 therein.

Four guides 362 stand at an interval of 90° along an end surface of the body 361, and have a shape of a plate having a plate surface along a circumferential direction of the body 361. The guide 362 is disposed so that one circle is formed when outer circumferential surfaces of the guide 362 are linked to each other, and a diameter of the circle is generally the same as a diameter of an inner circumferential surface of the tubular body 46. Therefore, when the end section of the body 361 butts against the tubular body 46, the outer circumferential surface of the guide 362 functions as a guide which advances sliding on the inner circumferential surface of the tubular body 46.

The notching blade 363 stands between the guides 362 adjacent to each other. Therefore, four notching blades 363 also stand at an interval of 90° along an end surface of the body 361. The notching blade 363 has a blade section of which a tip end is sharply formed, and an edge of the blade section extends in a radial direction of the body 361. Accordingly, as will be illustrated later, it is possible to make a cut in the end section of the tubular body 46 by the notching blade 363. Therefore, it is preferable that at least the notching blade 363 in the tool 360 is formed of metal.

By using the tool 360, for example, it is possible to detach the shaft member 70 from the bearing member 45 as follows.

First, as illustrated in FIG. 28A, an end section provided with a guide 162 and the notching blade 363 in the tool 360 approaches toward a side on which the shaft member 70 of the end member 40 protrudes. At this time, a part (coupling member 71 or the like) on which the shaft member 70 protrudes is inserted and accommodated in the body 361 in the tool 360.

Next, as the tool 360 further approaches the tubular body 46 of the end member 40 and a force is applied after coming into contact with the tubular body 46, the tool 360 is pressed. Accordingly, the guide 362 is input to the tubular body 46, and guides the tool 360, and the notching blade 363 makes a cut in the end section of the tubular body 46. After this, as can be ascertained from FIG. 28C, by eliminating the tool 360, a state where a cut 46a is input to the tubular body 46 is made.

When the cut is made in tubular body 46 in this manner, the tubular body 46 is likely to be deformed in a direction in which a diameter of the tubular body 46 widens. Then, as illustrated in FIG. 29, the protruding section 50a of the holding section 50 is also likely to move to an outer side in the radial direction of the tubular body 46 as illustrated with an arrow F, and the engagement with the spherical body 90 is likely to be released. In this state, when the shaft member 70 falls out as illustrated with an arrow G, the shaft member 70 is easily removed from the bearing member 45.

In the embodiment, by the deformation which causes damage to a part of the bearing member 45, the shaft member is detached from the bearing member. Therefore, the coupling member 71 is not damaged. In addition, by using the tool 270, it is possible to easily make a cut in the tubular body 46, and to efficiently detach the shaft member.

In the embodiment, it is possible to efficiently detach the shaft member by using the tool 360 as described above, but it is not necessary to always use the tool 360. For example, by using a tool having one blade, it is possible to similarly detach the shaft member from the bearing member even when the cut is provided in order as described above in the tubular body 46.

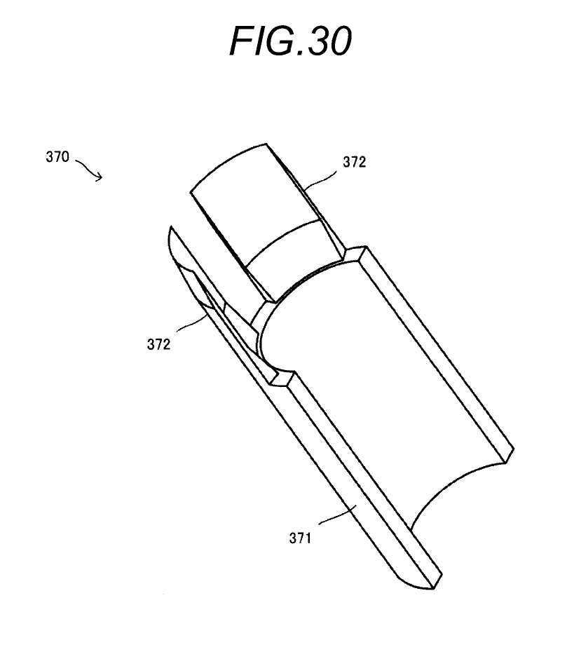

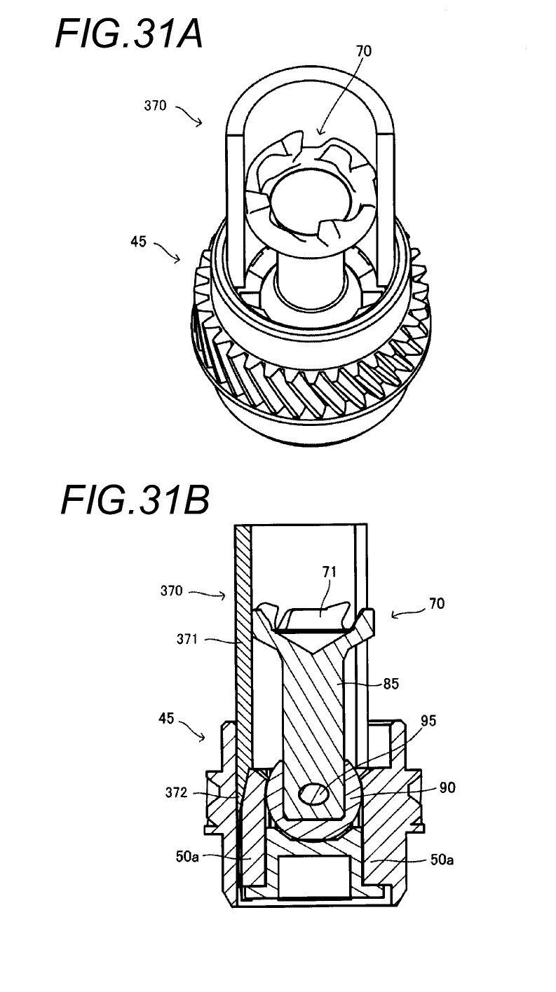

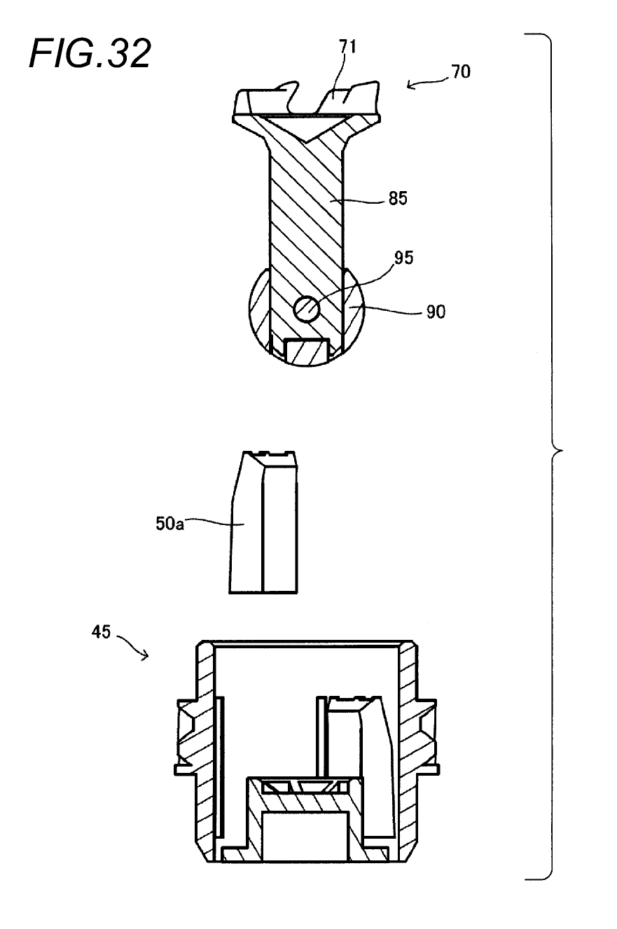

FIGS. 30 to 32 are diagrams illustrating a twelfth embodiment. The embodiment is also an example in which the shaft member is taken out by the deformation which is accompanied by damage of the bearing member. FIG. 30 is a perspective view of an external appearance of a tool 370 which is used in the twelfth embodiment. FIG. 31A is a perspective view of an external appearance illustrating one situation of a procedure of detaching the shaft member 70 from the bearing member 45 in the embodiment. FIG. 31B is a sectional view thereof. FIG. 32 is a sectional view illustrating another situation of a procedure of detaching the shaft member 70 from the bearing member 45 in the embodiment.

The tool 370 has a body 371 which is an embodiment cut in half along the axial line direction of the cylinder. Two notching blades 372 stand in the axial direction from one end surface of the body 371. Here, since the shaft member 70 is inserted into the body 371 in a procedure of detaching the shaft member 70, an inner diameter of the body 371 has a size which can input the coupling member 71 thereto.

Two notching blades 372 stand at a predetermined interval along the end surface of the body 371, and has a shape of a plate having a plate surface along the circumferential direction of the body 371, and tip end thereof has a sharp blade section. The notching blade 372 is bent along the inner circumferential surface of the tubular body 46, and accordingly, an edge of the blade section also is bent and extends along the inner surface of the tubular body 46. In addition, an interval between the two notching blades 372 corresponds to an interval between the protruding sections 50a of the holding section 50. Accordingly, as will be described later, it is possible to cut two protruding sections 50a at the same time by the two notching blades 372. From the above, it is preferable that at least the notching blade 372 of the tool 370 is formed of metal.

By using the tool 370, for example, it is possible to detach the shaft member 70 from the bearing member 45 as follows.

As can be ascertained from FIGS. 31A and 31B, while the notching blade 372 of the tool 370 is pressed along the inner surface of the tubular body 46 as necessary, the notching blade 372 moves in the axial direction. Accordingly, the notching blade 372 cuts the protruding section 50a provided with the holding section 50 of the tubular body 46.

By cutting the protruding section 50a, the shaft member 70 also follows the cut protruding section 50a and is disengaged from the tubular body 46 when the shaft member 70 is also pulled up, and the shaft member 70 can be easily detached from the tubular body 46.

Even in the embodiment, by damaging a part of the bearing member 45, the shaft member is detached from the bearing member. Accordingly, the coupling member 71 is not damaged. In addition, by using the tool, it is possible to easily cut the protruding section 50a, and to efficiently detach the shaft member.

In the embodiment, by using the tool 370 as described above, it is possible to efficiently detach the shaft member, but it is not necessary to always use the tool 370. For example, by using the tool having one blade, it is possible to similarly detach the shaft member from the bearing member even when the protruding section 50a is cut as described above.

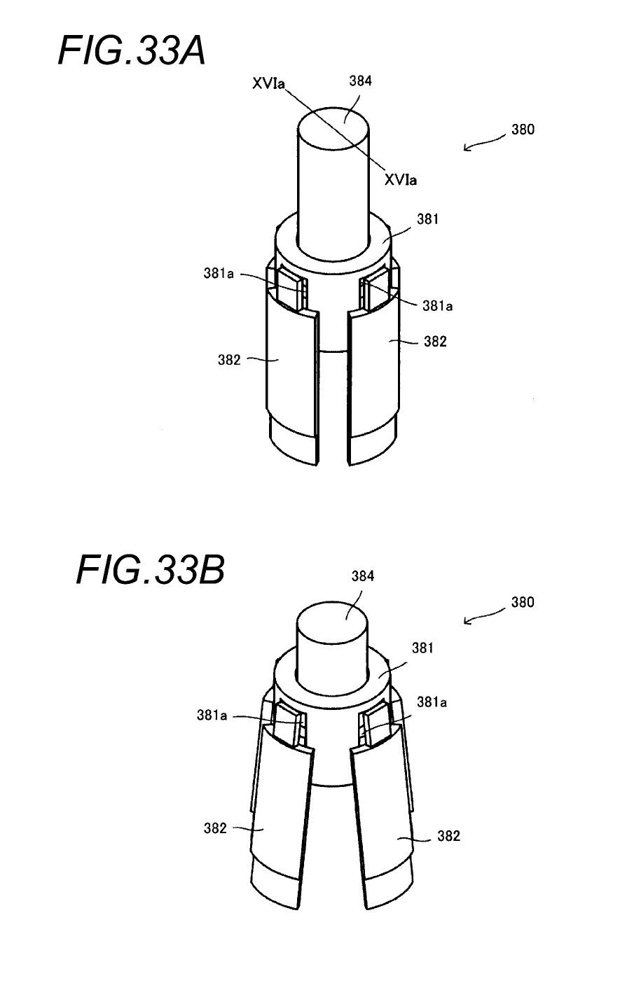

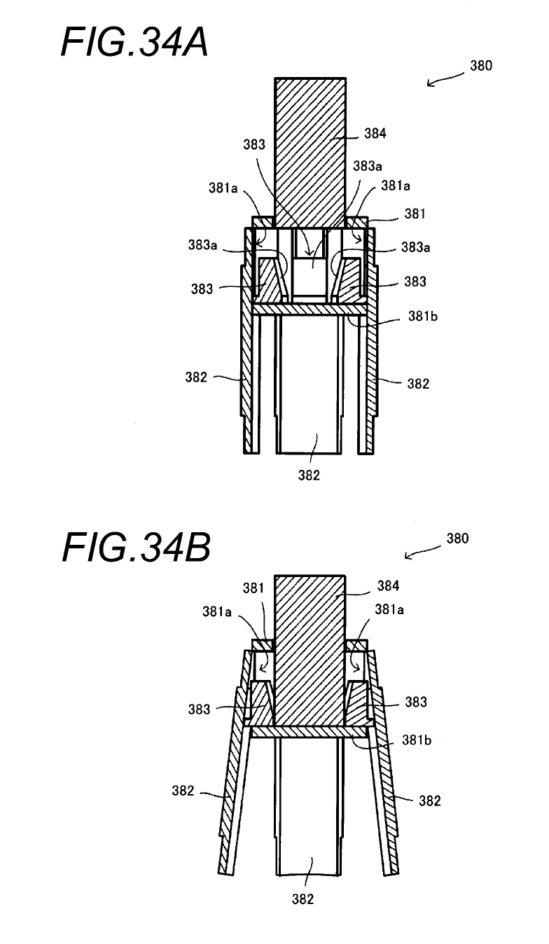

FIGS. 33A to 35B are diagrams illustrating a thirteenth embodiment. The embodiment is also an example in which the shaft member is taken out by the deformation which is accompanied by damage of the bearing member. FIGS. 33A to 34B are diagrams illustrating a tool 380 which is used in the thirteenth embodiment. FIG. 33A is a perspective view illustrating one posture of the tool 380. FIG. 33B is a perspective view illustrating another posture. FIG. 34A is a sectional view in the direction of the shaft member along line XVIa-XVIa in FIG. 33A. FIG. 34A is a sectional view of two swing blades 382 which oppose each other. FIG. 34B illustrates a sectional view from the same viewpoint as that of FIG. 34A, and is another posture of the tool 380.

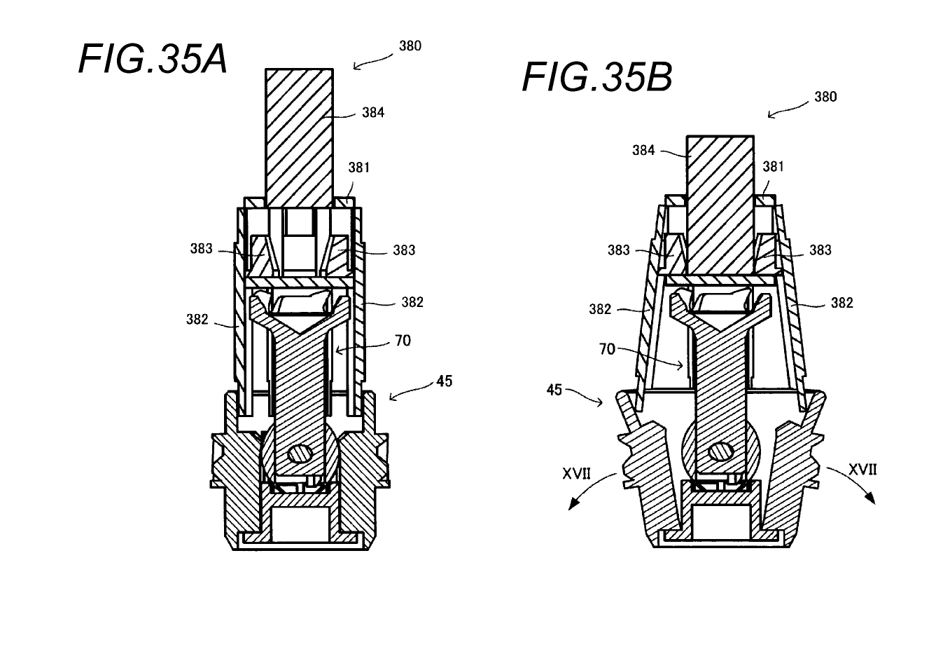

FIG. 35A is a sectional view illustrating one situation of a procedure of detaching the shaft member 70 from the bearing member 45 in the embodiment. FIG. 35B is a sectional view illustrating another situation of a procedure of detaching the shaft member 70 from the bearing member 45.

As can be ascertained from the drawings, the tool 380 has a circular base 381 having a bottom 381b. An opening 381a which makes the inside and the outside lead to each other at a position shifted by 90° is provided on a side wall of the base 381. In other words, in the embodiment, four openings 381a are provided. A plate-like swing blade 382 is provided in an outer circumferential section of the base 381.

One end side of the swing blade 382 is attached to the base 381 to be rotatable, and the other end side of the swing blade 382 is formed to extend further exceeding the base 381 on the bottom 381b side in the axial line direction of the base 381. Accordingly, as can be ascertained from the drawings, the swing blade 382 swings to take a posture (a closed posture in FIGS. 33A and 34A) in which a part of one surface thereof is disposed to overlap with an outer circumferential surface of the base 381, and a posture (an opened posture in FIGS. 33B and 34B) in which the other end side thereof is inclined to widen being the most separated from the shaft line. In addition, a swing blade 182 is disposed to block at least a part of the opening 381a on a base 181 in the closed posture. Therefore, in the embodiment, four swing blades 382 are disposed being shifted by 90°.

In addition, as can be ascertained from FIGS. 34A and 34B, sliding members 383 are provided with respect to each of the openings 381a inside the base 381. The sliding member 383 is configured to be able to move in the radial direction of the base 381 on the bottom 381b, on the tubular inner side of the base 381. In addition, by the movement, a part of the sliding member 383 is disposed to be projected from the opening 381a of the base 381.

Here, the sliding member 383 has an inclined surface 383a on a surface on a side facing the shaft line of the base 381. The inclined surface approaches the shaft line of the base 381 on the bottom 381b side, and is inclined to be separated from the shaft line of the base 381 along the direction of being separated from the bottom 381b.

Furthermore, a cylindrical cylinder 384 is provided in the tool 380. One end thereof is inserted from an opening of the end section on a side opposite to the bottom 381b of the base 381, and the shaft line of the base 381 and the shaft line of the cylinder 384 generally matches each other. In this state, the cylinder 384 can move in the axial line direction. The other end side of the cylinder 384 protrudes from the base 381. Therefore, the cylinder 384 extends to a side opposite to the direction in which the swing blade 382 extends.

The tool 380 can be deformed as follows. In other words, as illustrated in the postures in FIGS. 33A and 33B, the cylinder 384 largely protrudes from the base 381, the sliding member 383 is disposed at a position of being close to the shaft line of the base 381, and the cylinder 384 does not protrude from the opening 381a. At this time, the swing blade 382 takes a closed posture, and the extending direction thereof is generally parallel to the shaft line of the base 381.

From the posture, as illustrated in FIGS. 33B and 34B, the cylinder 384 is pushed toward the bottom 381b side of the base 381. Then, a tip end of the cylinder 384 comes into contact with the inclined surface 383a of the sliding member 383, and this part is further pressed. In addition, by an action of the inclined surface 383a, a force with which the sliding member 383 moves in the radial direction of the base 381 is obtained, and the sliding member 383 moves to protrude from the opening 381a of the base 381. Accordingly, since the sliding member 383 presses the swing blade 382, the swing blade 382 swings and is in the closed posture.

By using the tool 380, for example, it is possible to detach the shaft member 70 from the bearing member 45 as follows.

As can be ascertained from FIG. 35A, the tool 380 is in a closed posture. In this posture, a tip end of the swing blade 382 is put into the bearing member 45. At this time, the shaft member 70 protruded from the bearing member 45 is accommodated in a space on the inside which is surrounded by the swing blade 382.

Next, when the tool 380 is changed to be in an opened posture, as illustrated in FIG. 35B, the tip end of the swing blade 382 is opened, and a side wall of the bearing member 45 is pushed down as illustrated with an arrow XVII in FIG. 35B. Accordingly, the bearing member 45 is damaged, and the shaft member 70 is taken out.

Even in the embodiment, by damaging a part of the bearing member 45, the shaft member is detached from the bearing member. Accordingly, the coupling member 71 is not damaged. In addition, by using the tool, it is possible to damage the bearing member 45, and to efficiently detach the shaft member.

In each of the above-described embodiments, in order to more easily perform damaging, a process of cooling the bearing member in advance may be included. According to this, it is possible to deteriorate ductility of the bearing member, and to more smoothly damage the bearing member. At this time, the temperature may be cooled to be equal to or lower than brittle temperature.

As the cooling method, it is possible to use a known method, not being particularly limited. In addition to this, examples thereof include a method which uses liquid nitrogen, dry ice, alcohol, various types of refrigerants, or a combination of these materials.

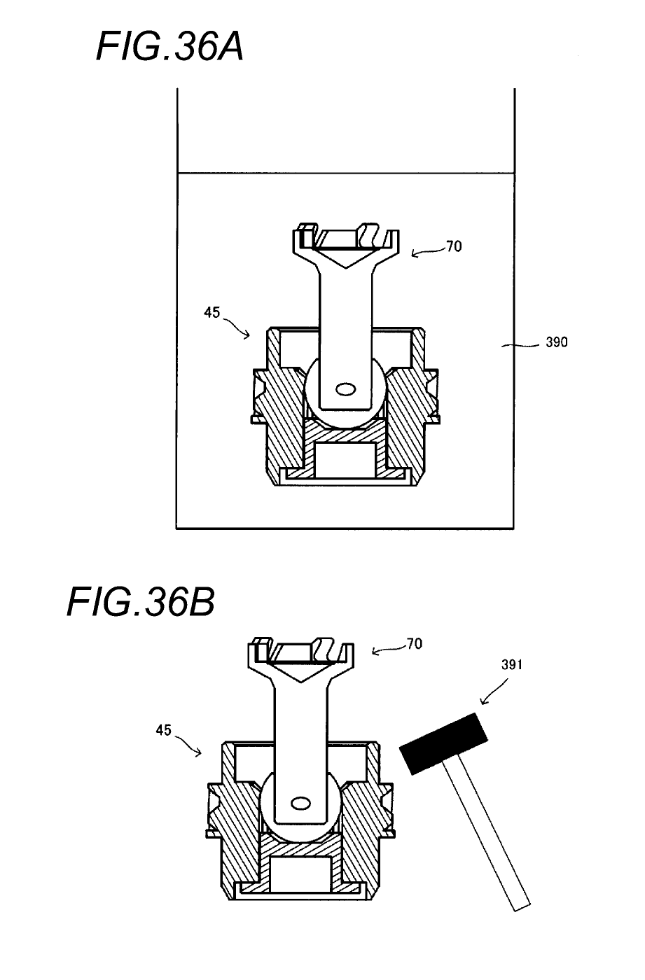

FIGS. 36A and 36B are diagrams illustrating a fourteenth embodiment. The embodiment is also an example of taking out the shaft member by the deformation which is accompanied by damage of the bearing member. FIG. 36A is a sectional view illustrating one situation of a procedure of detaching the shaft member 70 from the bearing member 45 in the embodiment. FIG. 36B is a sectional view illustrating another situation.

In the embodiment, as illustrated in FIG. 36A, the end member 40 is dipped in liquid nitrogen 390 and cooled, and after this, for example, as illustrated in FIG. 36B, an impact is imparted to the tubular body 46 by a hammer 391 or the like, and only the tubular body 46 is damaged. According to this, it is possible to detach the shaft member 70 from the bearing member 45.

Even in the embodiment, by damaging a part of the bearing member 45, the shaft member is detached from the bearing member. Accordingly, the coupling member 71 is not damaged.

In the embodiment, an example in which cooling is performed by using the liquid nitrogen is illustrated, but not being limited thereto, another method may be used if the bearing member can be cooled. In other words, if the bearing member can be cooled, ductility can deteriorate, and damaging is performed, the embodiment can be realized. Accordingly, if the bearing member is cooled regardless of the temperature, a constant effect is achieved. From the viewpoint of more easily performing damaging, it is preferable that the temperature is equal to or less than the brittle temperature. For example, when the bearing member is formed of a polyacetal resin, the temperature is preferably equal to or less than −40°. In order to make the temperature equal to or less than −40°, for example, in addition to a method by the liquid nitrogen, a method of combining alcohol with dry ice can be employed.

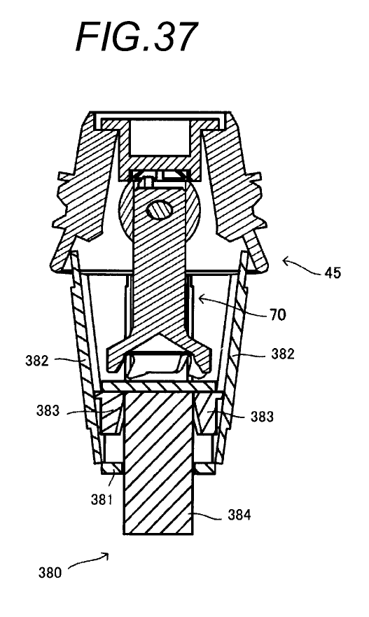

Next, a fifteenth embodiment will be described. The embodiment is an example in which the shaft member is taken out by the deformation which is accompanied by damage of the bearing member. Up to here, an example in which at least a part of the bearing member 45 is damaged and the shaft member 70 is taken out is described, but the shaft member 70 may be taken out by directly deforming the bearing member 45 without reaching a level of damaging. For example, when deforming the bearing member 45 by using the a tool 180 described above, if the tool 380 is a lower part and the bearing member 45 is an upper part as illustrated in FIG. 37 in an aspect of deformation before damaging the bearing member 45, the shaft member 70 is automatically lowered and falls out from the bearing member 45.

In this manner, if the bearing member 45 is directly deformed, and the shaft member is detached from the bearing member, the coupling member 71 is not damaged.

In addition, in order to more easily perform the deformation, a process of heating the bearing member in advance may be included. According to this, the bearing member is hardened, and can be deformed with less force. For example, in a case of polyacetal resin, it is possible to easily perform the deformation by heating the temperature up to approximately 165° C. of melting point. In addition, even without heating the temperature up to be close to the melting point, since a polyacetal resin is hardened due to heating, deformation is easily performed. For example, in a case of polyacetal resin, the deformation is possible with a weak force at approximately 120° C.

In addition, here, an example which uses the tool 380 is described, but means thereof is not particularly limited if the bearing member can be deformed. At this time, heating is not always necessary, but by heating the bearing member in advance, the deformation can be more easily performed.

According to the present invention, there are provided a shaft-member detachment method in which it is not necessary to impart a force to a rotating force receiving section when detaching a shaft member held by a bearing member in an end member, and it is possible to prevent a scratch or damage in the rotating force receiving section, and a shaft-member detaching tool. Accordingly, it is possible to enhance a quality of the shaft member to be reused.

What is claimed is:

1. A shaft-member detachment method for detaching a shaft member swingably held by a bearing member from the bearing member which transmits a rotating force to a photoreceptor drum,
wherein the shaft member includes a base end section received inside the bearing member, a rotating force transmission pin which protrudes from the base end section, and a rotating force receiving section which is disposed to protrude from the bearing member, and
the method includes a process of detaching the shaft member from the bearing member by a force acting on the base end section.

2. The shaft-member detachment method according to claim 1, wherein the detaching process includes a procedure of holding and pulling out the shaft member by nipping the base end section.

3. The shaft-member detachment method according to claim 1, wherein the detaching process includes a procedure of pulling out the shaft member while supporting at least one point on a side opposite to the rotating force receiving section in the base end section.

4. The shaft-member detachment method according to claim 1, wherein the detaching process includes a procedure in which one end of a bar-like member is brought into contact with the base end section and serves as a point of application, in which a part of the bar-like member is brought into contact with the bearing member and serves as a fulcrum, and a force is applied to the other end of the bar-like member and the other end serves as leverage.

5. The shaft-member detachment method according to claim 1, wherein the detaching process includes a procedure of pressing the base end section from a side opposite to the rotating force receiving section in the base end section.

6. A shaft-member detaching tool which is used in the shaft-member detachment method as defined in claim 2, the shaft-member detaching tool including at least two parts which sandwich the base end section.

7. A shaft-member detaching tool which is used in the shaft-member detachment method as defined in claim 3, the shaft-member detaching tool including a part which has a shape of a bar and makes the base end section hooked to a tip end of the bar-shaped part.

8. A shaft-member detaching tool which is used in the shaft-member detachment method as defined in claim 4, the shaft-member detaching tool including a part which has a shape of a bar and makes the base end section hooked to a tip end of the bar-shaped part.

9. A shaft-member detaching tool which is used in the shaft-member detachment method as defined in claim 5, the shaft-member detaching tool having a shape of a bar to be inserted into the bearing member.

10. A shaft-member detachment method for detaching a shaft member swingably held by a bearing member from the bearing member which transmits a rotating force to a photoreceptor drum,
wherein the shaft member includes a base end section received inside the bearing member, a rotating force transmission pin which protrudes from two locations of the base end section, and a rotating force receiving section which is disposed to protrude from the bearing member, and
the method includes a process of detaching the shaft member from the bearing member by a force acting on the rotating force transmission pin.

11. The shaft-member detachment method according to claim 10, wherein the detaching process includes a procedure of pulling out the shaft member while supporting at least two locations of the rotating force transmission pin.

12. The shaft-member detachment method according to claim 10, wherein the detaching process includes a procedure of pulling out the shaft member by catching the rotating force transmission pin with a wire and pulling the wire.

13. The shaft-member detachment method according to claim 10, wherein the detaching process includes a procedure of catching one rotating force transmission pin with the wire, pulling the wire, making the shaft member inclined, and applying a force in the direction in which the shaft member stands.

14. The shaft-member detachment method according to claim 10, wherein the detaching process includes a procedure in which one end of a bar-like member is brought into contact with the rotating force transmission pin and serves as a point of application, in which a part of the bar-like member is brought into contact with the bearing member and serves as a fulcrum, and a force is applied to the other end of the bar-like member and the other end serves as leverage.

15. A shaft-member detaching tool which is used in the shaft-member detachment method as defined in claim 11, the shaft-member detaching tool including at least two engagement sections which make each of one side end section and the other side end section of the rotating force transmission pin caught.

16. A shaft-member detachment method for detaching a shaft member swingably held by a bearing member from the bearing member which transmits a rotating force to a photoreceptor drum,
wherein the shaft member includes a base end section received inside the bearing member, a rotating force transmission pin which protrudes from two locations of the base end section, and a rotating force receiving section which is disposed to protrude from the bearing member, and
the method includes a process of detaching the shaft member from the bearing member by directly deforming at least a part of the bearing member.

17. The shaft-member detachment method according to claim 16, wherein the detaching process includes a procedure of at least partly damaging an outer circumferential section of the bearing member.

18. The shaft-member detachment method according to claim 16, wherein the detaching process includes a procedure of at least partly damaging a part which comes into contact with the base end section of the shaft member among parts received inside the bearing member.

19. The shaft-member detachment method according to claim 16, wherein the detaching process includes a procedure of pressing the shaft member toward an outside from an inside of the bearing member, and damaging an outer wall of the bearing member by pushing down the outer wall.

20. The shaft-member detachment method according to claim 16, further comprising a process of cooling the bearing member performed before the detaching process.

21. The shaft-member detachment method according to claim 16, wherein the detaching process includes a procedure of cooling the shaft member and the bearing member, and a procedure of imparting an impact to the bearing member after the cooling.

22. The shaft-member detachment method according to claim 16, wherein the detaching process includes a procedure of deforming which is not accompanied by damage after heating the bearing member.
